(19) United States
(12) Patent Application Publication
(10) Pub. No.: US 2025/0180707 A1
(43) Pub. Date: Jun. 5, 2025

(54) INCREASING SIGNAL TO NOISE RATIO OF A PIXEL OF A LIDAR SYSTEM

(71) Applicant: INNOVIZ TECHNOLOGIES LTD, Rosh HaYain (IL)

(72) Inventors: Ronen ESHEL, Herzliya (IL); ldan BAKISH, Hod Hasharon (IL); Shahar LEVY, Rishon LeZion (IL); Elchanan SHAPIRA, Kedumim (IL)

(21) Appl. No.: 18/843,561

(22) PCT Filed: Mar. 3, 2023
(86) PCT No.: PCT/IL2023/050218

§ 371 Date: Sep. 3, 2024

Related U.S. Application Data
(60) Provisional application No. 63/315,994, filed on Mar. 3, 2022.

(51) Int. Cl. G01S 7/481; G01S 17/931

(52) U.S. Cl. CPC G01S 7/4816; G01S 7/4817; G01S 17/931

(57) ABSTRACT

A LIDAR system and respective method are described. The LIDAR system comprising at least one light source configured for scanning a selected scene, a sensing unit comprising at least one pixel configured to generate output data indicative on light intensity collected by said at least one pixel, and a processing unit. The processing unit is configured and operable for periodically determining data on alignment measure based on output data received from the sensing unit, and for varying at least one of IFOV parameters, alignment of collected light reflected from said selected scene and readout of said at least one pixel of the sensing unit to improve signal to noise ratio (SNR) of said system.

### I. TECHNICAL FIELD

The present disclosure relates generally to surveying technology for scanning a surrounding environment, and, more specifically, to systems and methods that use LIDAR technology to detect objects in the surrounding environment.

### II. BACKGROUND INFORMATION

With the advent of driver assist systems and autonomous vehicles, automobiles need to be equipped with systems capable of reliably sensing and interpreting their surroundings, including identifying obstacles, hazards, objects, and other physical parameters that might impact navigation of the vehicle. To this end, a number of differing technologies have been suggested including radar, LIDAR, camera-based systems, operating alone or in a redundant manner.

One consideration with driver assistance systems and autonomous vehicles is an ability of the system to determine surroundings across different conditions including, rain, fog, darkness, bright light, and snow. A light detection and ranging system, (LIDAR a.k.a. LADAR) is an example of technology that can work well in differing conditions, by measuring distances to objects by illuminating objects with light and measuring the reflected pulses with a sensor. A laser is one example of a light source that can be used in a LIDAR system. As with any sensing system, in order for a LIDAR-based sensing system to be fully adopted by the automotive industry, the system should provide reliable data enabling detection of far-away objects.

A sensing unit of the LIDAR system may include multiple pixels. A pixel may include multiple sub-pixels, each sub-pixel may include one or more sensing elements such as but not limited to photodiodes.

Each sub-pixel may sense noise. Some of the sub-pixels may also a sense signal. At least some other sub-pixels do not sense any signal (and sense only noise).

The noise may be an infrared noise—but other noises may be sensed by the sub-pixels.

The output of all sub-pixels may be summed to provide a pixel output signal.

When adding the output of all sub-pixels—the signal to noise ratio (SNR) of the pixel output signal is reduced—at least in part, due to the sub-pixels that only sense noise.

There is a growing need to increase the SNR of a pixel.

The systems and methods of the present disclosure are directed towards improving the SNR of pixels.

### SUMMARY

According to some broad aspects of the present disclosure there may be provided a LIDAR system having an improved SNR.

According to one broad aspect, the present disclosure provides a LIDAR system comprising at least one light source configured for scanning a selected scene, a sensing unit comprising at least one pixel configured to generate output data indicative on light intensity collected by said at least one pixel; said processing unit is configured and operable for periodically determining data on alignment measure based on output data received from the sensing unit, and for varying at least one of IFOV parameters, alignment of collected light reflected from said selected scene and readout of said at least one pixel of the sensing unit to improve signal to noise ratio (SNR) of said system.

Generally, the output data may relate to sensor output. Such output data may be in the form of electrical signal produced by one or more photodetectors upon light detection. In some embodiments, the output data may be an analog signal indicative of summed or average output of a selected number of sub-pixels. In some additional embodiments, the output data may be a digital signal. The output data may be formed by an array of signals, each indicative of light intensity impinging on a selected sub-pixel. The at least one pixel is preferably placed for collecting light reflected from the scene to provide output data indicative of light reflected from the scene.

According to some embodiments, the LIDAR system further comprises a scanning unit comprising at least one light deflector positioned for receiving collected light reflected from one or more objects in the selected scene and direct the collected light to the sensing unit.

According to some embodiments, the LIDAR system further comprises an alignment unit configured for aligning path of collected light to impinge on IFOV of said at least one pixel, wherein said alignment unit is connected to a scanning unit at comprising least one light deflector to align path of collected light by deflecting said at least one light deflector.

According to some embodiments, the LIDAR system further comprises an alignment unit configured for aligning path of collected light to impinge on IFOV of said at least one pixel.

According to some embodiments, the alignment unit is connected to said sensing unit to align path of collected light by varying location of said at least one pixel.

According to some embodiments, the LIDAR system further comprises at least one optical element located in path of the collected or transmitted light and wherein said alignment unit is connected to said at least one optical element to align path of collected light by variation of orientation of said at least one optical element.

According to some embodiments, the at least one pixel comprises a plurality of sub-pixels and a readout circuit, and configured to generate output data on light intensity collected by a selected number of said plurality of sub-pixels, and wherein said processing unit generates operational instructions for selecting an arrangement and number of sub-pixels generating said output data for varying said at least one of IFOV parameters and alignment.

According to some embodiments, said periodically determining data on alignment measure comprises determining average SNR within one or more scans of a scene based on a relation between one or more signals associated with collected light reflected from one or more objects in the scene. Generally, the LIDAR system may be configured to determine alignment measure periodically during normal operation to improve SNR and align IFON and light collection, due to variation that may be cause from thermal changes, vibrations or any other variation in path for light collection.

According to some embodiments, the at least one pixel comprises at least first and second readout regions providing readout data on light impinging on at least first and second regions of the at least one pixel, said periodically determining data on alignment measure comprises determining a relation between readout from said at least first and second readout regions.

According to some embodiments, the at least one pixel is configured to provide top region readout and bottom region readout indicative of light impinging on at least one of top and bottom regions or right and left regions of area of said at least one pixel.

According to some embodiments, the at least one pixel is formed of at least first and second pixels position for detection of at least first and second portions of an illumination spot, said periodically determining data on alignment measure comprises determining a relation between readout from said at least two first and second pixels.

According to some embodiments, the at least one pixel comprises one or more additional light detectors, and wherein said sensing unit is aligned to direct collected light to impinge onto said at least one pixel and partially impinge the one or more additional light detectors, said periodically determining data on alignment measure comprises determining intensity distribution of light portion impinging on said one or more additional detectors.

According to some embodiments, the at least one pixel comprises an arrangement of a plurality of sub-pixel sensors, and wherein said sensing unit is configured to provide readout said plurality of sub-pixel sensors, said periodically determining data on alignment measure comprises processing readout distribution of said plurality of sub-pixels and determining signal data in accordance with a spatial cluster of sub-pixels readout indicating data on collected light.

According to some embodiments, the processing unit is configured for receiving input data indicative of individual readout of said plurality of sub-pixels and for processing said input data to determining signal collection; said processing comprises determining a spatial cluster of sub-pixels readout indicating data on collected light and determining one or more parameters of an object in accordance with arrangement of said spatial cluster of sub-pixels.

According to some embodiments, the one or more parameters of an object comprise object center of mass location, object dimension along at least one axis, and object reflectivity.

According to some embodiments, the processing unit is configured and operable for periodically determining data on alignment measure during typical ongoing operation.

According to one other broad aspect, the present disclosure provides method for use in operation of a LIDAR system, the method comprising receiving output data from at least one pixel, said output data being indicative of light reflected from a selected scene and impinging on said at least one pixel, determining data on alignment measure based on said output data from said at least one pixel, and calibrating collection of light by said at least one pixel, said calibrating collection of light comprises varying at least one of IFOV parameters, alignment of collected light reflected from said selected scene and readout of said at least one pixel of the sensing unit to improve signal to noise ratio (SNR) of said system.

According to some embodiments, said calibrating collection of light comprises generating operational instructions to an alignment unit for aligning path of collected light to impinge on effective sensing area of said at least one pixel.

According to some embodiments, said calibrating collection of light comprises generating operational instructions to a scanning unit of said LIDAR to align path of collected light by deflecting said at least one light deflector.

According to some embodiments, said calibrating collection of light comprises varying spatial alignment of said at least one pixel with respect to path of collected light.

According to some embodiments, the at least one pixel comprises a plurality of sub-pixels and a readout circuit and is configured to generate output data on light intensity collected by a selected number of said plurality of sub-pixels, and wherein said varying alignment of collected light comprises selecting an arrangement of sub-pixels to participate in generating said output data.

According to some embodiments, said determining an alignment measure comprises determining average SNR within one or more scans of a scene based on a relation between one or more signals associated with collected light reflected from one or more objects in the scene and collected noise.

According to some embodiments, the at least one pixel comprises at least first and second readout regions providing readout data on light impinging on said at least first and second regions, said determining an alignment measure comprises determining a relation between readout from said at least first and second readout regions.

According to some embodiments, the at least one pixel is configured to provide top region readout and bottom region readout indicative of light impinging on top and bottom halves of area of said at least one pixel.

According to some embodiments, the at least one pixel is formed of at least first and second pixels position for detection of at least first and second portions of an illumination spot, said periodically determining data on alignment measure comprises determining a relation between readout from said at least two first and second pixels.

According to some embodiments, the at least one pixel comprises one or more additional light detectors and is aligned to direct collected light to impinge onto said at least one pixel and the one or more additional light detectors, said determining an alignment measure comprises determining intensity distribution of light portion impinging on said one or more additional detectors.

According to some embodiments, the at least one pixel comprises an arrangement of a plurality of sub-pixel sensors, and wherein said sensing unit is configured to provide readout said plurality of sub-pixel sensors, said determining an alignment measure comprises processing readout distribution of said plurality of sub-pixels and determining signal data in accordance with a spatial cluster of sub-pixels readout indicating data on collected light.

According to some embodiments, said processing readout distribution comprises receiving input data indicative of individual readouts of said plurality of sub-pixels and processing said input data to determine signal collection by determining a spatial cluster of sub-pixels readout indicating data on collected light and determining one or more parameters of an object in accordance with arrangement of said spatial cluster of sub-pixels.

According to some embodiments, said one or more parameters of an object comprise object center of mass location, object dimension along at least one axis, and object reflectivity.

According to yet another broad aspect, the present disclosure provides a program storage device readable by machine, tangibly embodying a program of instructions executable by the machine to perform a method for use in operation of a LIDAR system, the method comprising receiving output data from at least one pixel, said output data being indicative of light impinging on said at least one pixel, determining data on alignment measure based on said output data from said at least one pixel, and calibrating collection of light by said at least one pixel, said calibrating collection of light comprises varying at least one of IFOV parameters, alignment of collected light reflected from said selected scene and readout of said at least one pixel of the sensing unit to improve signal to noise ratio (SNR) of said system. The program storage device may further comprise instructions for performing additional method actions as described herein.

According to yet another broad aspect, the present disclosure provides a computer program product comprising a computer useable medium having computer readable program code embodied therein for use in operation of a LIDAR system, the computer program product comprising computer readable instruction for:
obtaining output data from at least one pixel;
determining data on alignment measure based on said output data;
and calibrating collection of light by said at least one pixel;
wherein said calibrating collection of light comprises varying at least one of IFOV parameters, alignment of collected light reflected from said selected scene and readout of said at least one pixel of the sensing unit to improve signal to noise ratio (SNR) of said system. The computer program product may further comprise computer readable instruction for performing additional method actions as described herein.

According to yet another broad aspect, the present disclosure provides a method for determining an output of a pixel, the method comprises:
receiving pixel output signals during one or more learning periods, wherein the pixel comprises a first plurality of sub-pixels; wherein a value of pixel output signal is based on a value of at least one sub-pixel output signal; and
determining, based on one or more signal to noise (SNR) criteria, a number of pixel output signals to output from the pixel and a contribution of the first plurality of sub-pixels to each of the pixel output signals.

According to some embodiments, the one or more SNR criteria are selected out of obtaining a maximal SNR, providing a maximal SNR under a certain situation, or providing a maximal SNR under certain misalignments.

According to some embodiments, the one or more SNR criteria is associated with at least one out of time of day, illumination conditions, a date, weather conditions, a location, or one or more objects that are illuminated by the LIDAR system.

According to some embodiments, an aggregated length of the one or more learning periods is less than one second.

According to some embodiments, an aggregated length of the one or more learning periods is the duration of a single acquisition.

According to some embodiments, an aggregated length of the one or more learning periods is less than a minute.

According to some embodiments, an aggregated length of the one or more learning periods is more than an hour.

According to some embodiments, the pixel output signals include multiple pixel output signals from more than one pixel.

According to some embodiments, each of the more than one pixels have the same number of sub-pixels.

According to some embodiments, the difference between multiple pixel output signals is used for the determining of the number of pixel output signals to output.

### BRIEF DESCRIPTION

The accompanying drawings, which are incorporated in and constitute a part of this disclosure, illustrate various disclosed embodiments. In the drawings:

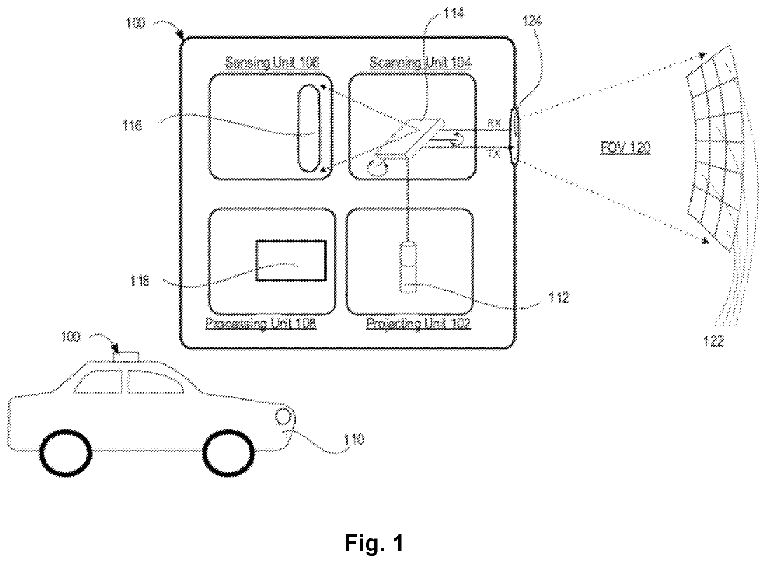

FIG. 1 illustrates an example of a LIDAR system;

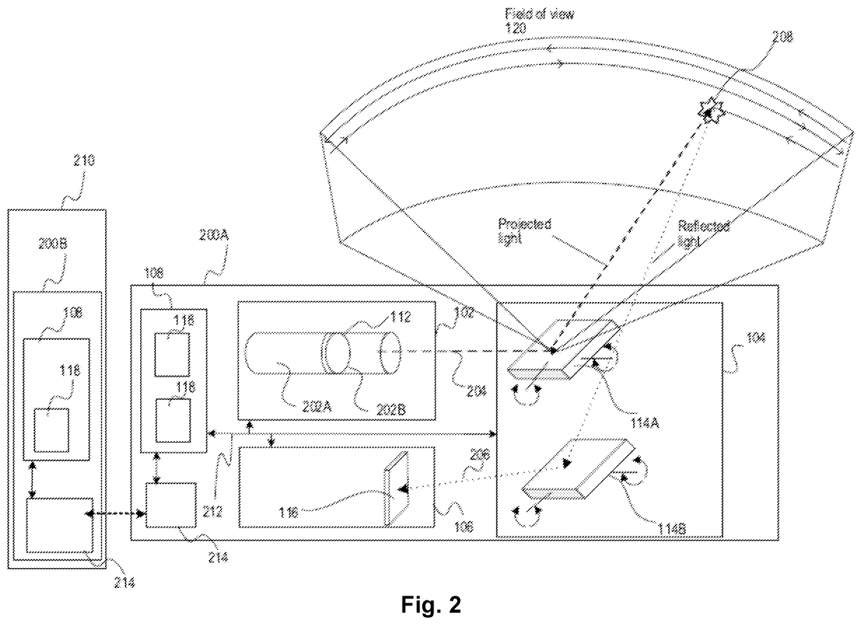

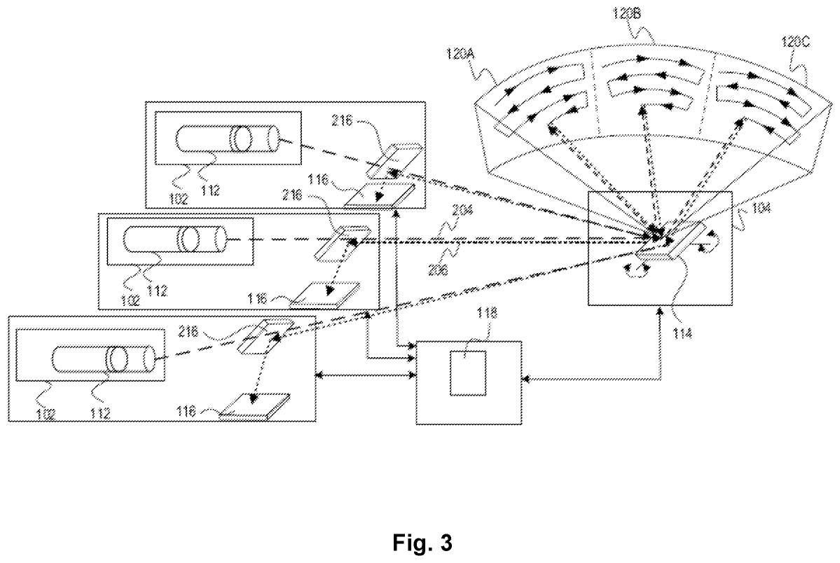

FIG. 2 and FIG. 3 illustrate various configurations of a projecting unit and its role in a LIDAR system;

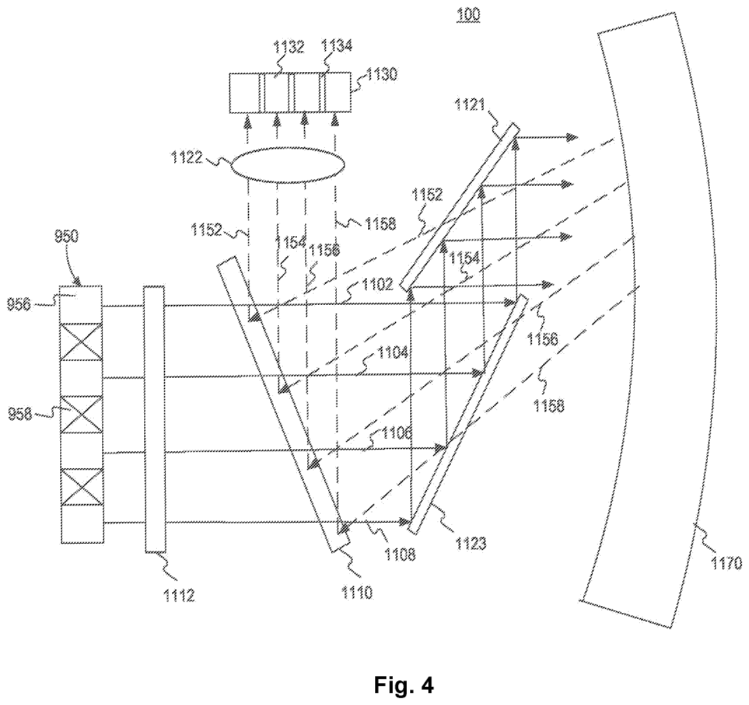

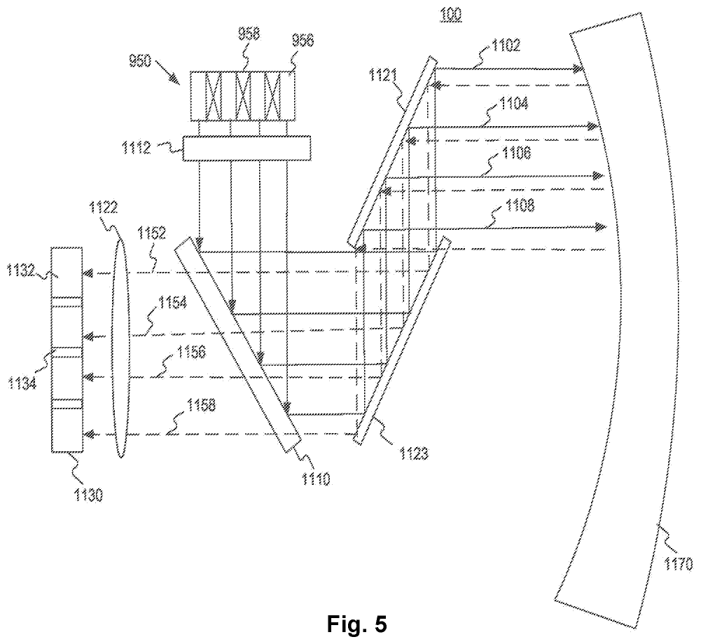

FIG. 4-FIG. 5 illustrate examples of a LIDAR system;

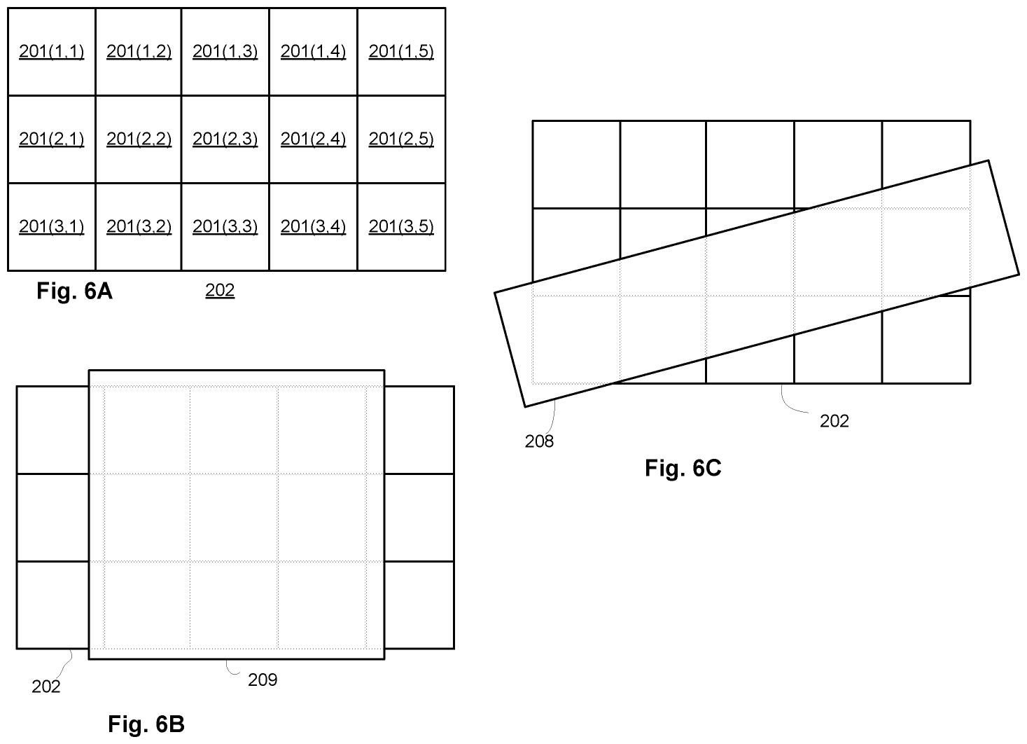

FIGS. 6A to 6C illustrate a pixel and subpixels arrangement, FIG. 6A illustrates sub-pixel arrangement forming a pixel, FIG. 6B illustrates an illumination spot impinging on parts of a pixel, and FIG. 6C illustrates another example of illumination spot falling on part of a pixel;

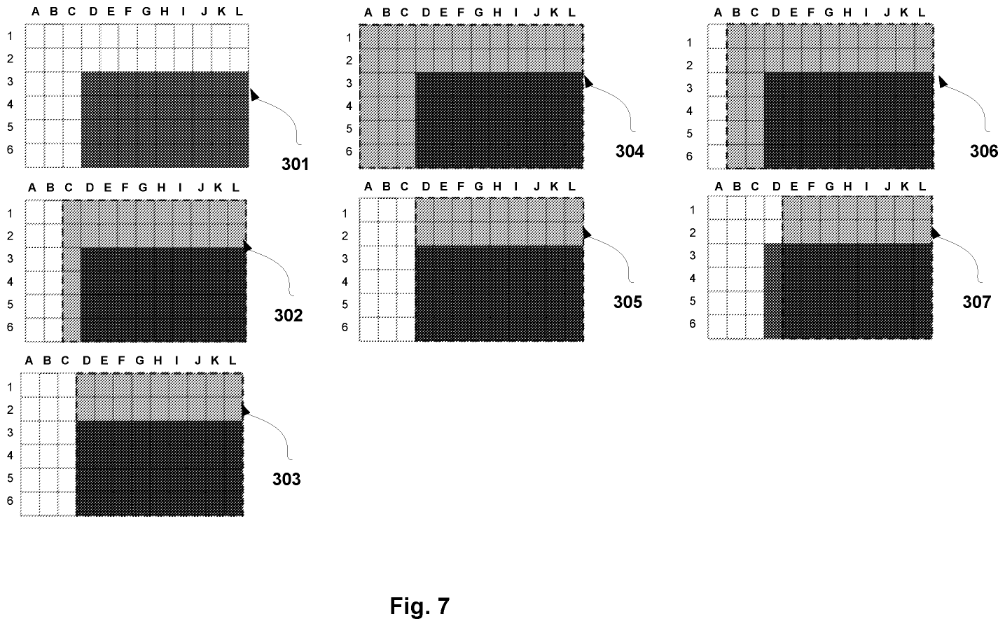

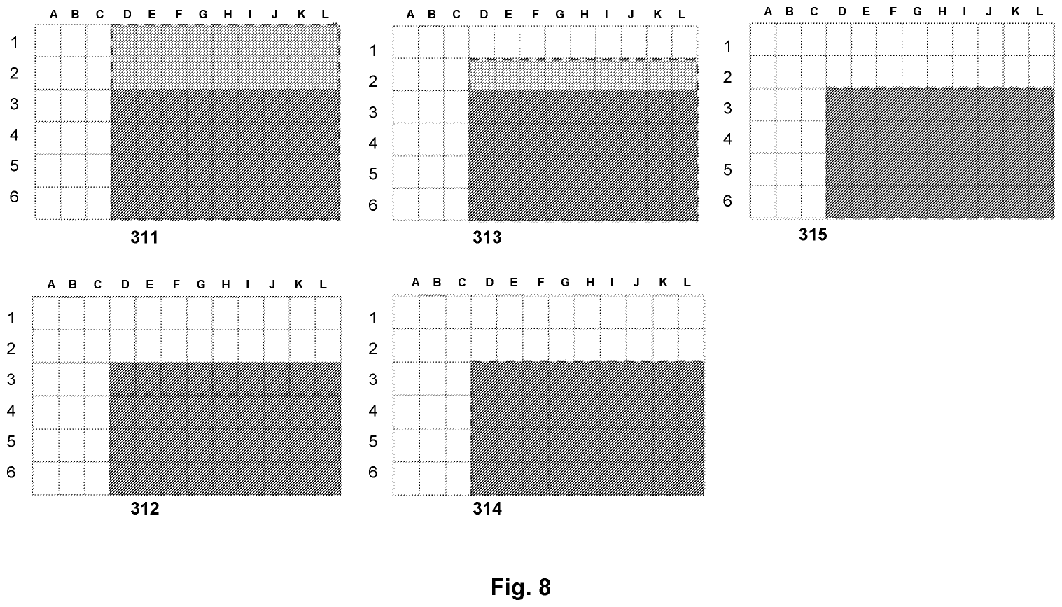

FIGS. 7 and 8 illustrate examples of an iterative evaluation of SNR.

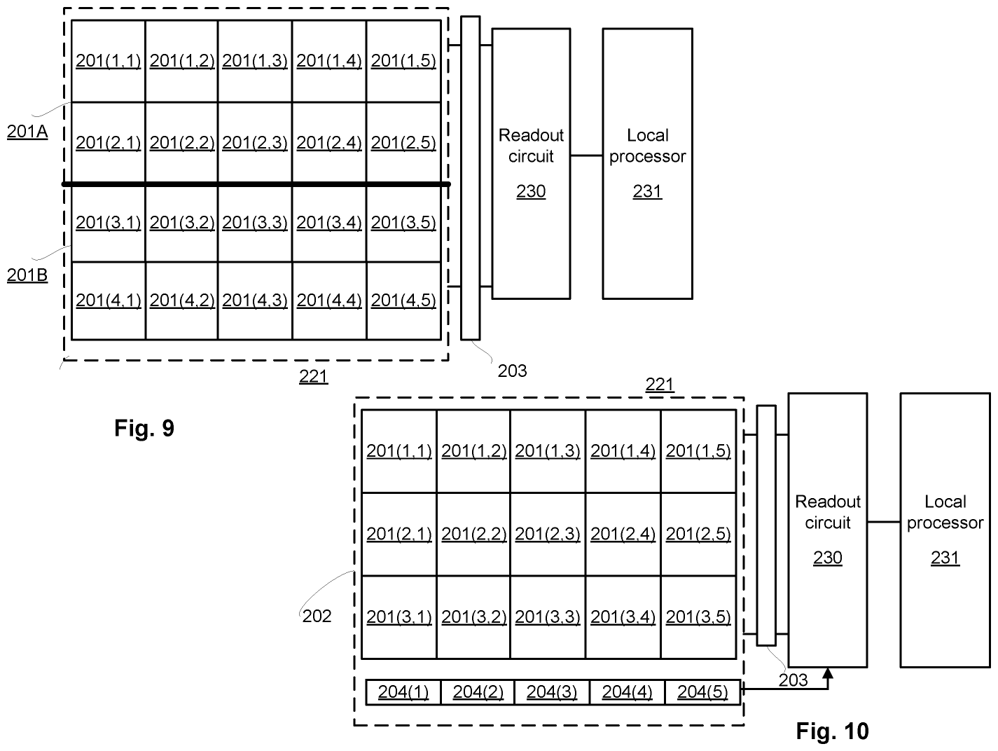

FIG. 9 exemplifies a pixel and additional circuit, where the pixel includes at least first and second pixel regions;

FIG. 10 exemplifies a pixel and additional circuit, where the pixel includes one or more additional light detectors;

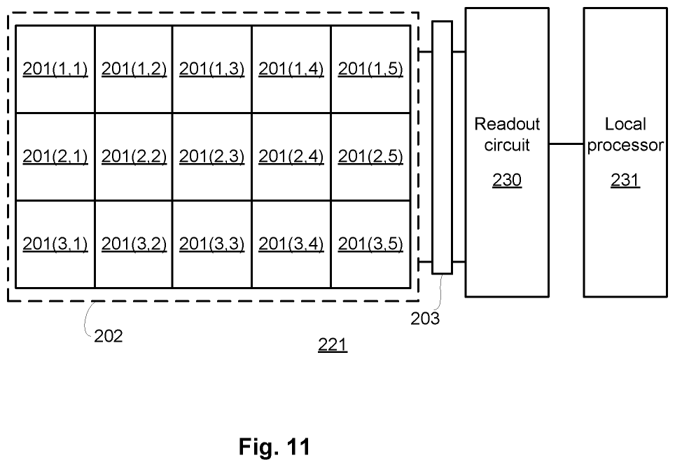

FIG. 11 illustrates an example of a pixel and additional circuits where the pixel is formed of a plurality of sub-pixels;

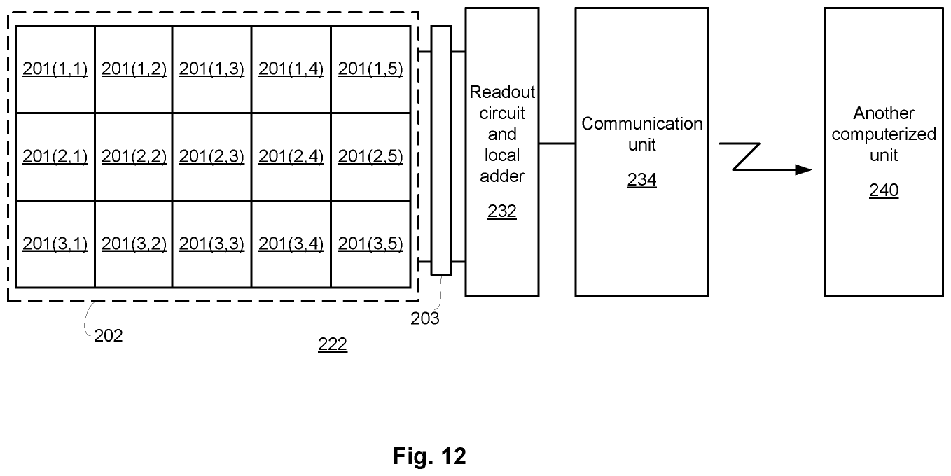

FIG. 12 illustrates another example of a pixel and additional circuits;

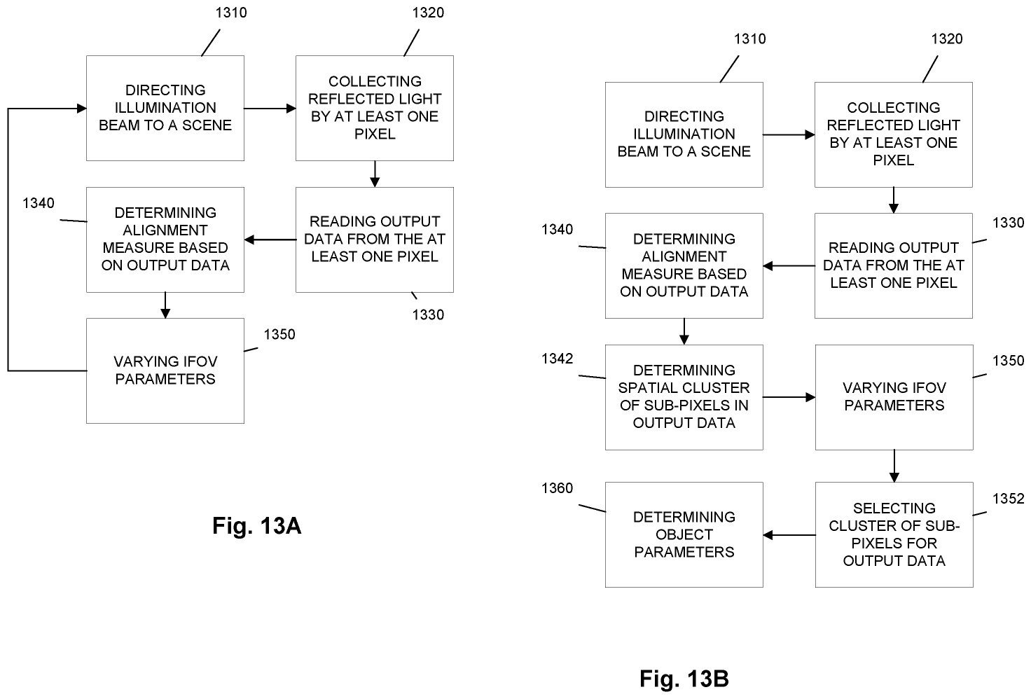

FIGS. 13A and 13B illustrate a block diagram describing method according to some embodiments of the disclosure; and

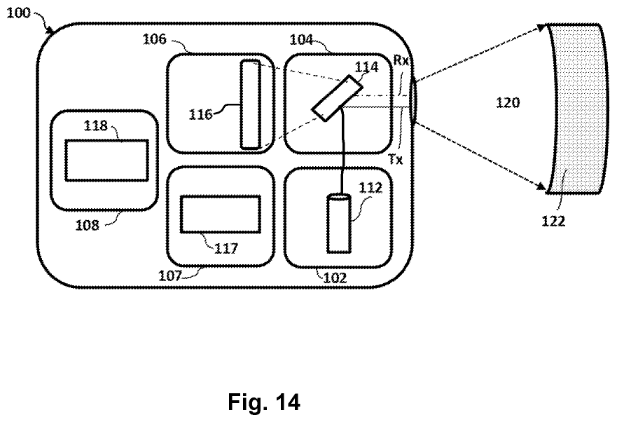

FIG. 14 illustrates as additional example of a LIDAR system

### TERMS DEFINITIONS

Disclosed embodiments may involve an optical system. As used herein, the term “optical system” broadly includes any system that is used for the generation, detection and/or manipulation of light. By way of example only, an optical system may include one or more optical components for generating, detecting and/or manipulating light. For example, light sources, lenses, mirrors, prisms, beam splitters, collimators, polarizing optics, optical modulators, optical switches, optical amplifiers, optical detectors, optical sensors, fiber optics, semiconductor optic components, while each not necessarily required, may each be part of an optical system. In addition to the one or more optical components, an optical system may also include other non-optical components such as electrical components, mechanical components, chemical reaction components, and semiconductor components. The non-optical components may cooperate with optical components of the optical system. For example, the optical system may include at least one processor for analyzing detected light.

Consistent with the present disclosure, the optical system may be a LIDAR system. As used herein, the term “LIDAR system” broadly includes any system which can determine values of parameters indicative of a distance between a pair of tangible objects based on reflected light. In one embodiment, the LIDAR system may determine a distance between a pair of tangible objects based on reflections of light emitted by the LIDAR system. As used herein, the term “determine distances” broadly includes generating outputs which are indicative of distances between pairs of tangible objects. The determined distance may represent the physical dimension between a pair of tangible objects. By way of example only, the determined distance may include a line of flight distance between the LIDAR system and another tangible object in a field of view of the LIDAR system. In another embodiment, the LIDAR system may determine the relative velocity between a pair of tangible objects based on reflections of light emitted by the LIDAR system. Examples of outputs indicative of the distance between a pair of tangible objects include: a number of standard length units between the tangible objects (e.g. number of meters, number of inches, number of kilometers, number of millimeters), a number of arbitrary length units (e.g. number of LIDAR system lengths), a ratio between the distance to another length (e.g. a ratio to a length of an object detected in a field of view of the LIDAR system), an amount of time (e.g. given as standard unit, arbitrary units or ratio, for example, the time it takes light to travel between the tangible objects), one or more locations (e.g. specified using an agreed coordinate system, specified in relation to a known location), and more.

The LIDAR system may determine the distance between a pair of tangible objects based on reflected light. In one embodiment, the LIDAR system may process detection results of a sensor which creates temporal information indicative of a period of time between the emission of a light signal and the time of its detection by the sensor. The period of time is occasionally referred to as “time of flight” of the light signal. In one example, the light signal may be a short pulse, whose rise and/or fall time may be detected in reception. Using known information about the speed of light in the relevant medium (usually air), the information regarding the time of flight of the light signal can be processed to provide the distance the light signal traveled between emission and detection. In another embodiment, the LIDAR system may determine the distance based on frequency phase-shift (or multiple frequency phase-shift). Specifically, the LIDAR system may process information indicative of one or more modulation phase shifts (e.g. by solving some simultaneous equations to give a final measure) of the light signal. For example, the emitted optical signal may be modulated with one or more constant frequencies. The at least one phase shift of the modulation between the emitted signal and the detected reflection may be indicative of the distance the light traveled between emission and detection. The modulation may be applied to a continuous wave light signal, to a quasi-continuous wave light signal, or to another type of emitted light signal. It is noted that additional information may be used by the LIDAR system for determining the distance, e.g. location information (e.g. relative positions) between the projection location, the detection location of the signal (especially if distanced from one another), and more.

In some embodiments, the LIDAR system may be used for detecting a plurality of objects in an environment of the LIDAR system. The term “detecting an object in an environment of the LIDAR system” broadly includes generating information which is indicative of an object that reflected light toward a detector associated with the LIDAR system. If more than one object is detected by the LIDAR system, the generated information pertaining to different objects may be interconnected, for example a car is driving on a road, a bird is sitting on the tree, a man touches a bicycle, a van moves towards a building. The dimensions of the environment in which the LIDAR system detects objects may vary with respect to implementation. For example, the LIDAR system may be used for detecting a plurality of objects in an environment of a vehicle on which the LIDAR system is installed, up to a horizontal distance of 100 m (or 200 m, 300 m, etc.), and up to a vertical distance of 10 m (or 25 m, 50 m, etc.). In another example, the LIDAR system may be used for detecting a plurality of objects in an environment of a vehicle or within a predefined horizontal range (e.g., 25°, 50°, 100°, 180°, etc.), and up to a predefined vertical elevation (e.g., ±10°, ±20°, ±40°-20°, ±90° or) 0°-90°.

As used herein, the term “detecting an object” may broadly refer to determining an existence of the object (e.g., an object may exist in a certain direction with respect to the LIDAR system and/or to another reference location, or an object may exist in a certain spatial volume). Additionally or alternatively, the term “detecting an object” may refer to determining a distance between the object and another location (e.g. a location of the LIDAR system, a location on earth, or a location of another object). Additionally or alternatively, the term “detecting an object” may refer to identifying the object (e.g. classifying a type of object such as car, plant, tree, road; recognizing a specific object (e.g., the Washington Monument); determining a license plate number; determining a composition of an object (e.g., solid, liquid, transparent, semitransparent); determining a kinematic parameter of an object (e.g., whether it is moving, its velocity, its movement direction, expansion of the object). Additionally or alternatively, the term “detecting an object” may refer to generating a point cloud map in which every point of one or more points of the point cloud map correspond to a location in the object or a location on a face thereof. In one embodiment, the data resolution associated with the point cloud map representation of the field of view may be associated with 0.1°×0.1° or 0.3°×0.3° of the field of view.

Consistent with the present disclosure, the term “object” broadly includes a finite composition of matter that may reflect light from at least a portion thereof. For example, an object may be at least partially solid (e.g. cars, trees); at least partially liquid (e.g. puddles on the road, rain); at least partly gaseous (e.g. fumes, clouds); made from a multitude of distinct particles (e.g. sand storm, fog, spray); and may be of one or more scales of magnitude, such as ˜1 millimeter (mm), ˜5 mm, ˜10 mm, ˜50 mm, ˜100 mm, ˜500 mm, ˜1 meter (m), ˜5 m, ˜10 m, ˜50 m, ˜100 m, and so on. Smaller or larger objects, as well as any size in between those examples, may also be detected. It is noted that for various reasons, the LIDAR system may detect only part of the object. For example, in some cases, light may be reflected from only some sides of the object (e.g., only the side opposing the LIDAR system will be detected); in other cases, light may be projected on only part of the object (e.g. laser beam projected onto a road or a building); in other cases, the object may be partly blocked by another object between the LIDAR system and the detected object; in other cases, the LIDAR's sensor may only detects light reflected from a portion of the object, e.g., because ambient light or other interferences interfere with detection of some portions of the object.

Consistent with the present disclosure, a LIDAR system may be configured to detect objects by scanning the environment of LIDAR system. The term “scanning the environment of LIDAR system” broadly includes illuminating the field of view or a portion of the field of view of the LIDAR system. In one example, scanning the environment of LIDAR system may be achieved by moving or pivoting a light deflector to deflect light in differing directions toward different parts of the field of view. In another example, scanning the environment of LIDAR system may be achieved by changing a positioning (i.e. location and/or orientation) of a sensor with respect to the field of view. In another example, scanning the environment of LIDAR system may be achieved by changing a positioning (i.e. location and/or orientation) of a light source with respect to the field of view. In yet another example, scanning the environment of LIDAR system may be achieved by changing the positions of at least one light source and of at least one sensor to move rigidly respect to the field of view (i.e. the relative distance and orientation of the at least one sensor and of the at least one light source remains).

As used herein the term “field of view of the LIDAR system” may broadly include an extent of the observable environment of LIDAR system in which objects may be detected. It is noted that the field of view (FOV) of the LIDAR system may be affected by various conditions such as but not limited to: an orientation of the LIDAR system (e.g. is the direction of an optical axis of the LIDAR system); a position of the LIDAR system with respect to the environment (e.g. distance above ground and adjacent topography and obstacles); operational parameters of the LIDAR system (e.g. emission power, computational settings, defined angles of operation), etc. The field of view of LIDAR system may be defined, for example, by a solid angle (e.g. defined using ϕ, θ angles, in which ϕ and θ are angles defined in perpendicular planes, e.g. with respect to symmetry axes of the LIDAR system and/or its FOV). In one example, the field of view may also be defined within a certain range (e.g. up to 200 m).

Similarly, the term “instantaneous field of view” may broadly include an extent of the observable environment in which objects may be detected by the LIDAR system at any given moment. For example, for a scanning LIDAR system, the instantaneous field of view is narrower than the entire FOV of the LIDAR system, and it can be moved within the FOV of the LIDAR system in order to enable detection in other parts of the FOV of the LIDAR system. The movement of the instantaneous field of view within the FOV of the LIDAR system may be achieved by moving a light deflector of the LIDAR system (or external to the LIDAR system), so as to deflect beams of light to and/or from the LIDAR system in differing directions. In one embodiment, LIDAR system may be configured to scan scene in the environment in which the LIDAR system is operating. As used herein the term “scene” may broadly include some or all of the objects within the field of view of the LIDAR system, in their relative positions and in their current states, within an operational duration of the LIDAR system. For example, the scene may include ground elements (e.g. earth, roads, grass, sidewalks, road surface marking), sky, man-made objects (e.g. vehicles, buildings, signs), vegetation, people, animals, light projecting elements (e.g. flashlights, sun, other LIDAR systems), and so on.

Any reference to the term “actuator” should be applied mutatis mutandis to the term “manipulator”. Non-limiting examples of manipulators include Micro-Electro-Mechanical Systems (MEMS) actuators, Voice Coil Magnets, motors, piezoelectric elements, and the like. It should be noted that a manipulator may be merged with a temperature control unit.

Disclosed embodiments may involve obtaining information for use in generating reconstructed three-dimensional models. Examples of types of reconstructed three-dimensional models which may be used include point cloud models, and Polygon Mesh (e.g. a triangle mesh). The terms “point cloud” and “point cloud model” are widely known in the art, and should be construed to include a set of data points located spatially in some coordinate system (i.e., having an identifiable location in a space described by a respective coordinate system). The term “point cloud point” refer to a point in space (which may be dimensionless, or a miniature cellular space, e.g. 1 cm3), and whose location may be described by the point cloud model using a set of coordinates (e.g. (X,Y,Z), (r,ϕ,θ)). By way of example only, the point cloud model may store additional information for some or all of its points (e.g. color information for points generated from camera images). Likewise, any other type of reconstructed three-dimensional model may store additional information for some or all of its objects. Similarly, the terms “polygon mesh” and “triangle mesh” are widely known in the art, and are to be construed to include, among other things, a set of vertices, edges and faces that define the shape of one or more 3D objects (such as a polyhedral object). The faces may include one or more of the following: triangles (triangle mesh), quadrilaterals, or other simple convex polygons, since this may simplify rendering. The faces may also include more general concave polygons, or polygons with holes. Polygon meshes may be represented using differing techniques, such as: Vertex-vertex meshes, Face-vertex meshes, Winged-edge meshes and Render dynamic meshes. Different portions of the polygon mesh (e.g., vertex, face, edge) are located spatially in some coordinate system (i.e., having an identifiable location in a space described by the respective coordinate system), either directly and/or relative to one another. The generation of the reconstructed three-dimensional model may be implemented using any standard, dedicated and/or novel photogrammetry technique, many of which are known in the art. It is noted that other types of models of the environment may be generated by the LIDAR system.

Consistent with disclosed embodiments, the LIDAR system may include at least one projecting unit with a light source configured to project light. As used herein the term “light source” broadly refers to any device configured to emit light. In one embodiment, the light source may be a laser such as a solid-state laser, laser diode, a high power laser, or an alternative light source such as, a light emitting diode (LED)-based light source. In addition, light source 112 as illustrated throughout the figures, may emit light in differing formats, such as light pulses, continuous wave (CW), quasi-CW, and so on. For example, one type of light source that may be used is a vertical-cavity surface-emitting laser (VCSEL). Another type of light source that may be used is an external cavity diode laser (ECDL). In some examples, the light source may include a laser diode configured to emit light at a wavelength between about 650 nm and 1150 nm. Alternatively, the light source may include a laser diode configured to emit light at a wavelength between about 800 nm and about 1000 nm, between about 850 nm and about 950 nm, or between about 1300 nm and about 1600 nm. Unless indicated otherwise, the term “about” with regards to a numeric value is defined as a variance of up to 5% with respect to the stated value. Additional details on the projecting unit and the at least one light source are described below with reference to FIGS. 2 and 3 of the current application and with reference to FIGS. 2A-2C of PCT patent application PCT/IB2020/055283 publication number WO2020/245767 which is incorporated herein by reference.

Consistent with disclosed embodiments, the LIDAR system may include at least one scanning unit with at least one light deflector configured to deflect light from the light source in order to scan the field of view. The term “light deflector” broadly includes any mechanism or module which is configured to make light deviate from its original path; for example, a mirror, a prism, controllable lens, a mechanical mirror, mechanical scanning polygons, active diffraction (e.g. controllable LCD), Risley prisms, non-mechanical-electro-optical beam steering (such as made by Vscent), polarization grating (such as offered by Boulder Non-Linear Systems), optical phased array (OPA), and more. In one embodiment, a light deflector may include a plurality of optical components, such as at least one reflecting element (e.g. a mirror), at least one refracting element (e.g. a prism, a lens), and so on. In one example, the light deflector may be movable, to cause light deviate to differing degrees (e.g. discrete degrees, or over a continuous span of degrees). The light deflector may optionally be controllable in different ways (e.g. deflect to a degree a, change deflection angle by Aa, move a component of the light deflector by M millimeters, change speed in which the deflection angle changes). In addition, the light deflector may optionally be operable to change an angle of deflection within a single plane (e.g., θ coordinate). The light deflector may optionally be operable to change an angle of deflection within two non-parallel planes (e.g., θ and ϕ coordinates). Alternatively or in addition, the light deflector may optionally be operable to change an angle of deflection between predetermined settings (e.g. along a predefined scanning route) or otherwise. With respect the use of light deflectors in LIDAR systems, it is noted that a light deflector may be used in the outbound direction (also referred to as transmission direction, or TX) to deflect light from the light source to at least a part of the field of view. However, a light deflector may also be used in the inbound direction (also referred to as reception direction, or RX) to deflect light from at least a part of the field of view to one or more light sensors. Additional details on the scanning unit and the at least one light deflector are described below with reference to FIGS. 3A-3C of PCT patent application PCT/IB2020/055283 publication number WO2020/245767 which is incorporated herein by reference.

Disclosed embodiments may involve pivoting the light deflector in order to scan the field of view. As used herein the term “pivoting” broadly includes rotating of an object (especially a solid object) about one or more axis of rotation, while substantially maintaining a center of rotation fixed. In one embodiment, the pivoting of the light deflector may include rotation of the light deflector about a fixed axis (e.g., a shaft), but this is not necessarily so. For example, in some MEMS mirror implementation, the MEMS mirror may move by actuation of a plurality of benders connected to the mirror, the mirror may experience some spatial translation in addition to rotation. Nevertheless, such mirror may be designed to rotate about a substantially fixed axis, and therefore consistent with the present disclosure it considered to be pivoted. In other embodiments, some types of light deflectors (e.g. non-mechanical-electro-optical beam steering, OPA) do not require any moving components or internal movements in order to change the deflection angles of deflected light. It is noted that any discussion relating to moving or pivoting a light deflector is also mutatis mutandis applicable to controlling the light deflector such that it changes a deflection behavior of the light deflector. For example, controlling the light deflector may cause a change in a deflection angle of beams of light arriving from at least one direction.

Disclosed embodiments may involve receiving reflections associated with a portion of the field of view corresponding to a single instantaneous position of the light deflector. As used herein, the term “instantaneous position of the light deflector” (also referred to as “state of the light deflector”) broadly refers to the location or position in space where at least one controlled component of the light deflector is situated at an instantaneous point in time, or over a short span of time. In one embodiment, the instantaneous position of light deflector may be gauged with respect to a frame of reference. The frame of reference may pertain to at least one fixed point in the LIDAR system. Or, for example, the frame of reference may pertain to at least one fixed point in the scene. In some embodiments, the instantaneous position of the light deflector may include some movement of one or more components of the light deflector (e.g. mirror, prism), usually to a limited degree with respect to the maximal degree of change during a scanning of the field of view. For example, a scanning of the entire the field of view of the LIDAR system may include changing deflection of light over a span of 30°, and the instantaneous position of the at least one light deflector may include angular shifts of the light deflector within 0.05°. In other embodiments, the term “instantaneous position of the light deflector” may refer to the positions of the light deflector during acquisition of light which is processed to provide data for a single point of a point cloud (or another type of 3D model) generated by the LIDAR system. In some embodiments, an instantaneous position of the light deflector may correspond with a fixed position or orientation in which the deflector pauses for a short time during illumination of a particular sub-region of the LIDAR field of view. In other cases, an instantaneous position of the light deflector may correspond with a certain position/orientation along a scanned range of positions/orientations of the light deflector that the light deflector passes through as part of a continuous or semi-continuous scan of the LIDAR field of view. In some embodiments, the light deflector may be moved such that during a scanning cycle of the LIDAR FOV the light deflector is located at a plurality of different instantaneous positions. In other words, during the period of time in which a scanning cycle occurs, the deflector may be moved through a series of different instantaneous positions/orientations, and the deflector may reach each different instantaneous position/orientation at a different time during the scanning cycle.

Consistent with disclosed embodiments, the LIDAR system may include at least one sensing unit with at least one sensor configured to detect reflections from objects in the field of view. The term “sensor” broadly includes any device, element, or system capable of measuring properties (e.g., power, frequency, phase, pulse timing, pulse duration) of electromagnetic waves and to generate an output relating to the measured properties. In some embodiments, the at least one sensor may include a plurality of detectors constructed from a plurality of detecting elements. The at least one sensor may include light sensors of one or more types. It is noted that the at least one sensor may include multiple sensors of the same type which may differ in other characteristics (e.g., sensitivity, size). Other types of sensors may also be used. Combinations of several types of sensors can be used for different reasons, such as improving detection over a span of ranges (especially in close range); improving the dynamic range of the sensor; improving the temporal response of the sensor; and improving detection in varying environmental conditions (e.g. atmospheric temperature, rain, etc.).

In one embodiment, the at least one sensor includes a SiPM (Silicon photomultipliers) which is a solid-state single-photon-sensitive device built from an array of avalanche photodiode (APD), single photon avalanche diode (SPAD), serving as detection elements on a common silicon substrate. In one example, a typical distance between SPADs may be between about 10 μm and about 50 μm, wherein each SPAD may have a recovery time of between about 20 ns and about 100 ns. Similar photomultipliers from other, non-silicon materials may also be used. Although a SiPM device works in digital/switching mode, the SiPM is an analog device because all the microcells may be read in parallel, making it possible to generate signals within a dynamic range from a single photon to hundreds and thousands of photons detected by the different SPADs. It is noted that outputs from different types of sensors (e.g., SPAD, APD, SiPM, PIN diode, Photodetector) may be combined together to a single output which may be processed by a processor of the LIDAR system. Additional details on the sensing unit and the at least one sensor are described below with reference to FIGS. 4 and 5 of the current application and with reference to FIGS. 4A-4C of PCT patent application PCT/IB2020/055283 publication number WO2020/245767 which is incorporated herein by reference.

Consistent with disclosed embodiments, the LIDAR system may include or communicate with at least one processor configured to execute differing functions. The at least one processor may constitute any physical device having an electric circuit that performs a logic operation on input or inputs. For example, the at least one processor may include one or more integrated circuits (IC), including Application-specific integrated circuit (ASIC), microchips, microcontrollers, microprocessors, all or part of a central processing unit (CPU), graphics processing unit (GPU), digital signal processor (DSP), field-programmable gate array (FPGA), or other circuits suitable for executing instructions or performing logic operations. The instructions executed by at least one processor may, for example, be pre-loaded into a memory integrated with or embedded into the controller or may be stored in a separate memory. The memory may comprise a Random Access Memory (RAM), a Read-Only Memory (ROM), a hard disk, an optical disk, a magnetic medium, a flash memory, other permanent, fixed, or volatile memory, or any other mechanism capable of storing instructions. In some embodiments, the memory is configured to store information representative data about objects in the environment of the LIDAR system. In some embodiments, the at least one processor may include more than one processor. Each processor may have a similar construction or the processors may be of differing constructions that are electrically connected or disconnected from each other. For example, the processors may be separate circuits or integrated in a single circuit. When more than one processor is used, the processors may be configured to operate independently or collaboratively. The processors may be coupled electrically, magnetically, optically, acoustically, mechanically or by other means that permit them to interact. Additional details on the processing unit and the at least one processor are described below with reference to FIGS. 6A to 6C of the current application and with reference to FIGS. 5A-5C of PCT patent application PCT/IB2020/055283 publication number WO2020/245767 which is incorporated herein by reference.

FIG. 1 illustrates a LIDAR system 100 including a projecting unit 102, a scanning unit 104, a sensing unit 106, and a processing unit 108. LIDAR system 100 may be mountable on a vehicle 110. Consistent with embodiments of the present disclosure, projecting unit 102 may include at least one light source 112, scanning unit 104 may include at least one light deflector 114, sensing unit 106 may include at least one sensor 116, and processing unit 108 may include at least one processor 118. In one embodiment, at least one processor 118 may be configured to coordinate operation of the at least one light source 112 with the movement of at least one light deflector 114 in order to scan a field of view 120. During a scanning cycle, each instantaneous position of at least one light deflector 114 may be associated with a particular portion 122 of field of view 120. In addition, LIDAR system 100 may include at least one optional optical window 124 for directing light projected towards field of view 120 and/or receiving light reflected from objects in field of view 120. Optional optical window 124 may serve different purposes, such as collimation of the projected light and focusing of the reflected light. In one embodiment, optional optical window 124 may be an opening, a flat window, a lens, or any other type of optical window.

Consistent with the present disclosure, LIDAR system 100 may be used in autonomous or semi-autonomous road-vehicles (for example, cars, buses, vans, trucks and any other terrestrial vehicle). Autonomous road-vehicles with LIDAR system 100 may scan their environment and drive to a destination vehicle without human input. Similarly, LIDAR system 100 may also be used in autonomous/semi-autonomous aerial-vehicles (for example, UAV, drones, quadcopters, and any other airborne vehicle or device); or in an autonomous or semi-autonomous water vessel (e.g., boat, ship, submarine, or any other watercraft). Autonomous aerial-vehicles and water craft with LIDAR system 100 may scan their environment and navigate to a destination autonomously or using a remote human operator. According to one embodiment, vehicle 110 (either a road-vehicle, aerial-vehicle, or watercraft) may use LIDAR system 100 to aid in detecting and scanning the environment in which vehicle 110 is operating.

It should be noted that LIDAR system 100 or any of its components may be used together with any of the example embodiments and methods disclosed herein. Further, while some aspects of LIDAR system 100 are described relative to an exemplary vehicle-based LIDAR platform, LIDAR system 100, any of its components, or any of the processes described herein may be applicable to LIDAR systems of other platform types.

In some embodiments, LIDAR system 100 may include one or more scanning units 104 to scan the environment around vehicle 110. LIDAR system 100 may be attached or mounted to any part of vehicle 110. Sensing unit 106 may receive reflections from the surroundings of vehicle 110, and transfer reflections signals indicative of light reflected from objects in field of view 120 to processing unit 108. Consistent with the present disclosure, scanning units 104 may be mounted to or incorporated into a bumper, a fender, a side panel, a spoiler, a roof, a headlight assembly, a taillight assembly, a rear-view mirror assembly, a hood, a trunk or any other suitable part of vehicle 110 capable of housing at least a portion of the LIDAR system. In some cases, LIDAR system 100 may capture a complete surround view of the environment of vehicle 110. Thus, LIDAR system 100 may have a 360-degree horizontal field of view. In one example, as shown in FIG. 1, LIDAR system 100 may include a single scanning unit 104 mounted on a roof vehicle 110. Alternatively, LIDAR system 100 may include multiple scanning units (e.g., two, three, four, or more scanning units 104) each with a field of few such that in the aggregate the horizontal field of view is covered by a 360-degree scan around vehicle 110. One skilled in the art will appreciate that LIDAR system 100 may include any number of scanning units 104 arranged in any manner, each with an 80° to 120° field of view or less, depending on the number of units employed. Moreover, a 360-degree horizontal field of view may be also obtained by mounting a multiple LIDAR systems 100 on vehicle 110, each with a single scanning unit 104. It is nevertheless noted that the one or more LIDAR systems 100 do not have to provide a complete 360° field of view, and that narrower fields of view may be useful in some situations. For example, vehicle 110 may require a first LIDAR system 100 having a field of view of 75° looking ahead of the vehicle, and possibly a second LIDAR system 100 with a similar FOV looking backward (optionally with a lower detection range). It is also noted that different vertical field of view angles may also be implemented.

### The Projecting Unit

FIGS. 2 and 3 depict various configurations of projecting unit 102 and its role in LIDAR system 100. Specifically, FIG. 2 is a diagram illustrating projecting unit 102 with a single light source; FIG. 3 is a diagram illustrating a plurality of projecting units 102 with a plurality of light sources aimed at a common light deflector 114. One skilled in the art will appreciate that the depicted configurations of projecting unit 102 may have numerous variations and modifications. Non limiting examples are provided in FIGS. 2C-2G of PCT patent application PCT/IB2020/055283 publication number WO2020/245767 which is incorporated herein by reference.

FIG. 2 illustrates an example of a bi-static configuration of LIDAR system 100 in which projecting unit 102 includes a single light source 112. The term “bi-static configuration” broadly refers to LIDAR systems configurations in which the projected light exiting the LIDAR system and the reflected light entering the LIDAR system pass through substantially different optical paths. In some embodiments, a bi-static configuration of LIDAR system 100 may include a separation of the optical paths by using completely different optical components, by using parallel but not fully separated optical components, or by using the same optical components for only part of the of the optical paths (optical components may include, for example, windows, lenses, mirrors, beam splitters, etc.). In the example depicted in FIG. 2A, the bi-static configuration includes a configuration where the outbound light and the inbound light pass through a single optical window 124 but scanning unit 104 includes two light deflectors, a first light deflector 114A for outbound light and a second light deflector 114B for inbound light (the inbound light in LIDAR system includes emitted light reflected from objects in the scene, and may also include ambient light arriving from other sources).

In this embodiment, all the components of LIDAR system 100 may be contained within a single housing 200, or may be divided among a plurality of housings. As shown, projecting unit 102 is associated with a single light source 112 that includes a laser diode 202A (or one or more laser diodes coupled together) configured to emit light (projected light 204). In one non-limiting example, the light projected by light source 112 may be at a wavelength between about 800 nm and 950 nm, have an average power between about 50 mW and about 500 mW, have a peak power between about 50 W and about 200 W, and a pulse width of between about 2 ns and about 100 ns. In addition, light source 112 may optionally be associated with optical assembly 202B used for manipulation of the light emitted by laser diode 202A (e.g. for collimation, focusing, etc.). It is noted that other types of light sources 112 may be used, and that the disclosure is not restricted to laser diodes. In addition, light source 112 may emit its light in different formats, such as light pulses, frequency modulated, continuous wave (CW), quasi-CW, or any other form corresponding to the particular light source employed. The projection format and other parameters may be changed by the light source from time to time based on different factors, such as instructions from processing unit 108. The projected light is projected towards an outbound deflector 114A that functions as a steering element for directing the projected light in field of view 120. In this example, scanning unit 104 also include a pivotable return deflector 114B that direct photons (reflected light 206) reflected back from an object 208 within field of view 120 toward sensor 116. The reflected light is detected by sensor 116 and information about the object (e.g., the distance to object 212) is determined by processing unit 108.

In this figure, LIDAR system 100 is connected to a host 210. Consistent with the present disclosure, the term “host” refers to any computing environment that may interface with LIDAR system 100, it may be a vehicle system (e.g., part of vehicle 110), a testing system, a security system, a surveillance system, a traffic control system, an urban modelling system, or any system that monitors its surroundings. Such computing environment may include at least one processor and/or may be connected LIDAR system 100 via the cloud. In some embodiments, host 210 may also include interfaces to external devices such as camera and sensors configured to measure different characteristics of host 210 (e.g., acceleration, steering wheel deflection, reverse drive, etc.). Consistent with the present disclosure, LIDAR system 100 may be fixed to a stationary object associated with host 210 (e.g. a building, a tripod) or to a portable system associated with host 210 (e.g., a portable computer, a movie camera). Consistent with the present disclosure, LIDAR system 100 may be connected to host 210, to provide outputs of LIDAR system 100 (e.g., a 3D model, a reflectivity image) to host 210. Specifically, host 210 may use LIDAR system 100 to aid in detecting and scanning the environment of host 210 or any other environment. In addition, host 210 may integrate, synchronize or otherwise use together the outputs of LIDAR system 100 with outputs of other sensing systems (e.g. cameras, microphones, radar systems). In one example, LIDAR system 100 may be used by a security system.

LIDAR system 100 may also include a bus 212 (or other communication mechanisms) that interconnect subsystems and components for transferring information within LIDAR system 100. Optionally, bus 212 (or another communication mechanism) may be used for interconnecting LIDAR system 100 with host 210. In the example of FIG. 2A, processing unit 108 includes two processors 118 to regulate the operation of projecting unit 102, scanning unit 104, and sensing unit 106 in a coordinated manner based, at least partially, on information received from internal feedback of LIDAR system 100. In other words, processing unit 108 may be configured to dynamically operate LIDAR system 100 in a closed loop. A closed loop system is characterized by having feedback from at least one of the elements and updating one or more parameters based on the received feedback. Moreover, a closed loop system may receive feedback and update its own operation, at least partially, based on that feedback. A dynamic system or element is one that may be updated during operation.

According to some embodiments, scanning the environment around LIDAR system 100 may include illuminating field of view 120 with light pulses. The light pulses may have parameters such as: pulse duration, pulse angular dispersion, wavelength, instantaneous power, photon density at different distances from light source 112, average power, pulse power intensity, pulse width, pulse repetition rate, pulse sequence, pulse duty cycle, wavelength, phase, polarization, and more. Scanning the environment around LIDAR system 100 may also include detecting and characterizing various aspects of the reflected light. Characteristics of the reflected light may include, for example: time-of-flight (i.e., time from emission until detection), instantaneous power (e.g., power signature), average power across entire return pulse, and photon distribution/signal over return pulse period. By comparing characteristics of a light pulse with characteristics of corresponding reflections, a distance and possibly a physical characteristic, such as reflected intensity of object 212 may be estimated. By repeating this process across multiple adjacent portions 122, in a predefined pattern (e.g., raster, Lissajous or other patterns) an entire scan of field of view 120 may be achieved. As discussed below in greater detail, in some situations LIDAR system 100 may direct light to only some of the portions 122 in field of view 120 at every scanning cycle. These portions may be adjacent to each other, but not necessarily so.

In another embodiment, LIDAR system 100 may include network interface 214 for communicating with host 210 (e.g., a vehicle controller). The communication between LIDAR system 100 and host 210 is represented by a dashed arrow. In one embodiment, network interface 214 may include an integrated services digital network (ISDN) card, cable modem, satellite modem, or a modem to provide a data communication connection to a corresponding type of telephone line. As another example, network interface 214 may include a local area network (LAN) card to provide a data communication connection to a compatible LAN. In another embodiment, network interface 214 may include an Ethernet port connected to radio frequency receivers and transmitters and/or optical (e.g., infrared) receivers and transmitters. The specific design and implementation of network interface 214 depends on the communications network(s) over which LIDAR system 100 and host 210 are intended to operate. For example, network interface 214 may be used, for example, to provide outputs of LIDAR system 100 to the external system, such as a 3D model, operational parameters of LIDAR system 100, and so on. In other embodiment, the communication unit may be used, for example, to receive instructions from the external system, to receive information regarding the inspected environment, to receive information from another sensor, etc.

FIG. 3 illustrates an example of a monostatic configuration of LIDAR system 100 including a plurality projecting units 102. The term “monostatic configuration” broadly refers to LIDAR system configurations in which the projected light exiting from the LIDAR system and the reflected light entering the LIDAR system pass through substantially similar optical paths. In one example, the outbound light beam and the inbound light beam may share at least one optical assembly through which both outbound and inbound light beams pass. In another example, the outbound light may pass through an optical window (not shown) and the inbound light radiation may pass through the same optical window. A monostatic configuration may include a configuration where the scanning unit 104 includes a single light deflector 114 that directs the projected light towards field of view 120 and directs the reflected light towards a sensor 116. As shown, both projected light 204 and reflected light 206 hits an asymmetrical deflector 216. The term “asymmetrical deflector” refers to any optical device having two sides capable of deflecting a beam of light hitting it from one side in a different direction than it deflects a beam of light hitting it from the second side. In one example, the asymmetrical deflector does not deflect projected light 204 and deflects reflected light 206 towards sensor 116. One example of an asymmetrical deflector may include a polarization beam splitter. In another example, asymmetrical 216 may include an optical isolator that allows the passage of light in only one direction. A diagrammatic representation of asymmetrical deflector 216 is illustrated in FIG. 2D. Consistent with the present disclosure, a monostatic configuration of LIDAR system 100 may include an asymmetrical deflector to prevent reflected light from hitting light source 112, and to direct all the reflected light toward sensor 116, thereby increasing detection sensitivity.

In the embodiment of FIG. 3, LIDAR system 100 includes three projecting units 102 each with a single of light source 112 aimed at a common light deflector 114. In one embodiment, the plurality of light sources 112 (including two or more light sources) may project light with substantially the same wavelength and each light source 112 is generally associated with a differing area of the field of view (denoted in the figure as 120A, 120B, and 120C). This enables scanning of a broader field of view than can be achieved with a light source 112. In another embodiment, the plurality of light sources 102 may project light with differing wavelengths, and all the light sources 112 may be directed to the same portion (or overlapping portions) of field of view 120.

FIG. 4 illustrates an exemplary LIDAR system 100 including beam splitter 1110. As illustrated in FIG. 4, LIDAR system 100 may include monolithic laser array 950 configured to emit one or more beams of laser light (e.g., 1102, 1104, 1106, 1108). The one or more beams of laser light may be collimated by one or more collimators 1112 before beams 1102, 1104, 1106, and/or 1108 are incident on beam splitter 1110. Beam splitter 1110 may allow laser light beams 1102, 1104, 1106, and/or 1108 to pass through and be incident on deflectors 1121, 1123, which may be configured to direct laser light beams 1102, 1104, 1106, and/or 1108 towards FOV 1170. Although only two deflectors 1121, 1123 have been illustrated in FIG. 4, it is contemplated that LIDAR system 100 may include more than two deflectors 1121, 1123 configured to direct one or more of the light beams 1102, 1104, 1106, and/or 1108 towards FOV 1170.

One or more objects in FOV 170 may reflect one or more of the light beams 1102, 1104, 1106, and/or 1108. As illustrated in 4, the reflected light beams may be represented as laser light beams 1152, 1154, 1156, and/or 1158. Although reflected laser light beams 1152, 1154, 1156, and/or 1158 are illustrated in FIG. 4 as being directly incident on beam splitter 1110, it is contemplated that some or all of light beams 1152, 1154, 1156, and/or 1158 may be directed by deflectors 1121, 1123 and/or another deflector towards beam splitter 1110. When light beams 1152, 1154, 1156, and/or 1158 reach splitter 1110, splitter 1110 may be configured to direct reflected light beams 1152, 1154, 1156, and/or 1158 received from FOV 1170 towards detector 1130 via lens 1122. Although FIG. 4 illustrates four light beams being emitted by monolithic laser array 950, it is contemplated that monolithic laser array 950 may emit any number of light beams (e.g., less than or more than four).

In some embodiments, the beam splitter is configured to re-direct each of the plurality of laser beams and pass a plurality of reflected beams received from the field of view of the LIDAR system. By way of example, FIG. 5 illustrates an exemplary LIDAR system 100 that may include monolithic laser array 950, collimator 1112, beam splitter 1110, deflector 1121, 1123, lens and/or optical filter 1122 and detector 1130. A monolithic laser array 950 may emit one or more laser light beams 1102, 1104, 1106, and/or 1108 that may be collimated by one or more collimators 1112 before being incident on beam splitter 1110.

Beam splitter 1110 may be configured to direct one or more of the laser light beams 1102, 1104, 1106, and/or 1108 towards deflectors 1121, 1123, which in turn may be configured to direct the one or more laser light beams 1102, 1104, 1106, and/or 1108 towards FOV 1170. One or more objects in FOV 1170 may reflect one or more of the laser light beams 1102, 1104, 1106, and/or 1108. Reflected laser light beams 1152, 1154, 1156, and/or 1158 may be directed by deflectors 1121, 1123 to be incident on beam splitter 1110. It is also contemplated that some or all of reflected laser light beams 1152, 1154, 1156, and/or 1158 may reach beam splitter 1110 without being directed by deflector 1121, 1123 towards beam splitter 1110.

As illustrated in FIG. 5 beam splitter 1110 may be configured to allow the reflected laser light beams 1152, 1154, 1156, and/or 1158 to pass through beam splitter 1110 towards detector 1130. One or more lenses and/or optical filters 1122 may receive the reflected laser light beams 1152, 1154, 1156, and/or 1158 and direct these light beams towards detector 1130. Although FIG. 5 illustrates four light beams being admitted by monolithic laser array 950, it is contemplated that monolithic laser array 950 may emit any number of light beams (e.g., less than or more than four).

### DETAILED DESCRIPTION

The accompanying drawings, which are incorporated in and constitute a part of this disclosure, illustrate various disclosed embodiments. The following detailed description refers to the accompanying drawings. Wherever possible, the same reference numbers are used in the drawings and the following description to refer to the same or similar parts. While several illustrative embodiments are described herein, modifications, adaptations and other implementations are possible. For example, substitutions, additions or modifications may be made to the components illustrated in the drawings, and the illustrative methods described herein may be modified by substituting, reordering, removing, or adding steps to the disclosed methods. Accordingly, the following detailed description is not limited to the disclosed embodiments and examples. Instead, the proper scope is defined by the appended.

### Improving Signal to Noise Ratio of a Pixel

There may be a method for determining an output of one or more pixels. The method may include collecting output data from the one or more pixels, determining an alignment measure indicative, and varying at least one of respective alignment of collected light and IFOV for output data collection from the one or more pixels, and one or more parameters of IFOV for output data collection.

There may also be provided a method for determining an output of a pixel, the method may include (a) receiving pixel output signals during one or more learning periods, wherein the pixel comprises a first plurality of sub-pixels; wherein a value of pixel output signal is based on a value of at least one sub-pixel output signal; and (b) determining, based on one or more signal to noise (SNR) criteria, a number of pixel output signals to output from the pixel and a contribution of the first plurality of sub-pixels to each of the pixel output signals.

A value of pixel output signal may be a function (sum, weighted sum, average, and the like) of one or more sub-pixel output signals. A sub-pixel may or may not contribute to a certain pixel output signal.

The one or more SNR criteria may be selected out of obtaining a maximal SNR, providing a maximal SNR under a certain situation, or providing a maximal SNR under certain misalignments.

The one or more SNR criteria may be associated with at least one parameter out of time of day, illumination conditions, a date, weather conditions, a location, or one or more objects that are illuminated by the LIDAR system.

The aggregated length of the one or more learning periods may be less than one second, less than a minute, more than a minute, more than an hour, less than an hour, less than a day, more than a day, less than a week, more than a week, less than a month, more than a month, and the like. The learning period may be the duration of a single acquisition.

The method may include configuring the pixel according to the determination-setting the number of pixel output signals and setting the contribution of the first plurality of sub-pixels to each of the pixel output signals. Different pixel output signals may be affected by output signals of different sub-pixels.

There may be provided a solution for improving a SNR of a pixel that includes sub-pixels.

The improvement may take into account other considerations-such as optical module misalignments, captured situations (situations that were captured by the pixel), and the like. The solution may provide a trade-off between SNR and the scope of the instantaneous field of view of the pixel.

A pixel may include an SiPM (Silicon photomultipliers) or any other solid-state device comprising an array of avalanche photodiodes (APD, SPAD, etc.) on a common silicon substrate or any other device capable of measuring properties (e.g., power, frequency) of electromagnetic waves and generating an output (e.g., a digital signal) relating to the measured properties. The sub-pixel may include a single element of the array (for example—a single SPAD).

Assuming that a pixel includes a first plurality (Nsp) of sub-pixels, and that the pixel may output any number of pixel output signals-between one (a single pixel output) to a second plurality of pixel output signals.

Each pixel output signal may represent one or more sub-pixel output signals.
a. For example—there may be a pixel output signal per each of the Nsp sub-pixels—to provide Nsp pixel output signals.
b. Yet for another example—there may be provided only a single pixel output signal—that may be a function (for example sum or weighted sum) of all sub-pixels output signals.
c. Yet for another example—there may be at least one pixel output signal that is a sum of any combination of some of the sub-pixels output signals.

Referring to FIG. 6A to 6C. FIG. 6A illustrates a pixel 202 including fifteen sub-pixels 20(1,1)-201(3,5) that are arranged in five columns and three rows; FIG. 6B exemplifies illumination spot 209 formed by collected light impinging on the pixel 202; and FIG. 6C exemplifies illumination spot 208 that may be formed by light reflection from certain objects (typically small objects) impinging on the pixel 202. The pixel may include any number of sub-pixels, any number of rows and any number of columns.

A pixel 202 output signal may equal a sub-pixel output signal. A pixel output signal may equal a sum of all fifteen sub-pixel 201 output signals. A pixel output signal may be a sum of a combination of any selected number of sub-pixel 201 output signals, being in this example a number between two and fourteen sub-pixel output signals. In some embodiments, as described in more detail further below, the pixel output may be an array of outputs of the sub-pixels thereof.

If the pixels outputs two or more pixel output signals-then different pixel output signals may represent sums of different combinations of sub-pixel output signals.

The summation of the sub-pixel output signals may be done in the analog domain.

The summation of the sub-pixel output signals may be done in the digital domain.

One or more summations of sub-pixel output signals may be done in the analog domain and one or more other summations may be done in the digital domain.

There may be provided a method that determines the number of pixel output signals (for example—between 1 and a second plurality) and a content of each outputted pixel output signal. Content—which sub-pixel output signals contribute to a pixel output signal.

The determination may be executed to fulfill one or more SNR criteria—for example to obtain a maximal SNR, to provide a maximal SNR in a specific scenario, to provide a maximal SNR under certain misalignments, and the like. Any reference to a maximal may be applied mutatis mutandis to a sub-maximal SNR. Situation may refer, for example to at least one out of time of day, illumination conditions, date, weather conditions, location, one or more objects that are illuminated by the LIDAR system, and the like.

The determination may be based on signals generated by the pixel during one or more learning periods having a length that may range between a fraction of a second, less than a minute, more than a minute, less than an hour, more than an hour, and the like.

The determination may be based on a learning period that is relatively long (e.g. more than a minute, or an hour), suitable to optimize for misalignments that develop due to environmental parameters that change slowly, and impact the system alignment over longer time frames, such as ambient temperature effects.

The pixel may belong to an optical module of the LIDAR system. The determination may be executed only by the optical module, may be determined by a computerized system other than the optical module, or may be determined by a cooperation between the optical module and the other computerized system.

Referring back to FIG. 6A, pixel 202 is exemplified including fifteen sub-pixels 20(1,1)-201(3,5) that are arranged in five columns and three rows. The pixel may include any number of sub-pixels, any number of rows and any number of columns. The plurality of sub-pixels may be operated together to provide output data indicative of an instantaneous FOV (IFOV). More specifically, the projection unit 102, scanning unit 104 and sensing unit 106, as well as any optical elements used in the system may preferably be aligned to provide that an illumination beam transmitted by the projection unit 102 toward an object and collected and directed by the scanning unit 104 to be detected by at least one pixel of the sensing unit 106 is aligned with the at least one pixel of the sensing unit.

Alignment of the respective elements of the LIDAR system may be mechanical alignment, associated with position and orientation of the elements along a common optical path. Additionally or alternatively alignment may be provided by proper readout from the plurality of sub-pixels 201 of pixel 202 collecting a reflected signal. Further, any sub-pixel 201 that is used for readout while not specifically collecting light reflected from an object in the scene effectively adds noise to the readout data. This is as such sub-pixels may generally collect ambient photons originating from the environment rather than the reflected light 206.

A misalignment may have various causes including, for example, thermal fluctuations, system vibrations, scattering elements such as dust, and any other cause. Such misalignment may result in a situation where readout of signal from at least one pixel includes a number of sub-pixels that are not aligned with illumination spot of reflected light, while sum of the reflected light might not be collected by sub-pixels being read.

Further, FIGS. 6B and 6C illustrate two cases in which only a part of the overall area of the pixel is illuminated by light reflected from an object (by a signal).

For example, FIG. 6B illustrates a reflected light spot that impinges on the pixel to form a rectangular spot 209 that “covers” central sub-pixels 201(1,2)-201(1,4), 201(2,2)-201(2,4), and 201(3,2)-201(3,4), and only barley “covers” external sub-pixels 201(1,1), 201(1,5), 201(2,1), 201(2,5), 201(3,1), and 201(3,5). In this case it may be beneficial to ignore the external sub-pixels in readout data, as the external sub-pixels 201(1,1), 201(1,5), 201(2,1), 201(2,5), 201(3,1), may contribute to noise while generally not contribute to collected signal.

In an additional example, FIG. 6C illustrates a reflected light spot that impinges on the pixel 202 to form a rectangular spot 208 diagonally covering regions of the pixel 202. The light spot fully “covers” sub-pixel 201(3,1), covers a substantial part of sub-pixels 201(3,2), 201(3,3), 201(2,2), 201(2,3), 201(2,4), 201(2,5), and barely covers sub-pixels 201(3,4), 201(3,5), 201(1,4) and 201(1,5). Sub-pixels 201(1,1)-201(1,3) are not covered at all.

In this case, it may be beneficial, to ignore sub-pixels 201(1,1)-201(1,3), and it may be beneficial ignore sub-pixels 201(3,4), 201(3,5), 201(1,4) and 201(1,5).

For example, determination of alignment of illumination spot on the at least one pixel 202, either by alignment of one or more optical elements or by selection of sub-pixels 201 participating in readout data from the pixel 202 may be done using an optimization to increase signal to noise ratio. The optimization may be performed over time, using a process of trial and error, to determine the optimal subset of sub-pixels to sum for each pixel. In some further embodiments, the optimization may utilize predetermined alignment measure, being an average data over one or more scan or instantaneous data based on relation between output signal of the at least one pixel.

In order to ensure no signal is lost, the detector or pixel size may be designed to be larger than the expected pixel. This allows for the entire reflected signal to impinge on the pixel, which may be summed. However, pixels that do not detect a target only contribute noise to the overall signal, which is why determining the relevant pixels may improve detection. To increase signal to noise ratio a selected portion of the pixel may be used to contribute to output data, while other regions of the pixel may not be summed and may be ignored in the output data.

To this end the LIDAR system of the present disclosure utilizes determining an alignment measure, indicative of alignment of illumination spot 209 or 208 formed by collected light impinging on the at least one pixel 202 and region of the pixel 202 being read to provide output data. Using the alignment measure the present disclosure provides for varying alignment of collected light and readout of said at least one pixel 202 to improve signal to noise ratio (SNR) of the LIDAR system. Alignment of the collected light and readout of the at least one pixel may be performed by various techniques including, for example, optimization of alignment.

The optimization may include signals (i.e. reflections, or received echoes) that provide a high confidence for the optimization, for example, signals from targets in specific distance range from the LIDAR system. For example, the distance range may be 100-200 m, or 150-250 m from the LIDAR system. The optimization may ignore detections outside this range. The system may exclude specific targets. For example, the system may exclude targets that saturate the sub-pixel, or targets with low signals, since this may complicate the optimization. Alternatively, the optimization may include only signals with a specific region in the FOV. For example, if a region of interest (ROI) is defined, only signals received from targets in the ROI may be included.

As indicated above, the optimization may be directed at optimizing alignment by varying alignment of the scanning unit 104 or alignment of the sensing unit 106. In some embodiments, the LIDAR system may utilize one or more optical elements located in path of collected light such as prisms, lenses, mirrors etc. In such embodiments, the optimization may operate to vary alignment of collected light by variation in orientation of the one or more optical elements used. Further, in some embodiments, as described above, the optimization may utilize variation of sub-pixels used in readout of output data from the at least one pixel of the sensing unit and selecting one or more sub-pixels that are included or not in providing output signal.

For example, the optimization may utilize setting an initial set of sub-pixels used in output data readout. Such initial set may include all sub-pixels, a set of sub-pixels located at center part of the pixel region, or any other initial set determined based on system design. In different optimization steps, some of the sub-pixels may be de-activated, such that their detections do not contribute to the sum of all of the sub-pixels. This may be done on a row/column basis. FIG. 7 illustrates seven steps 301-307 of column-by-column SNR evaluation while FIG. 8 illustrates five steps 311-315 of a row-by-row evaluation of the SNR.

Accordingly in some embodiments utilizing optimization based on SNR, if the SNR increases when a row is excluded, the row may be excluded from the summation. If the SNR decreases when the row is excluded, the row should be included in the summation. If the SNR increases when a column is excluded, the column may be excluded from the summation. If the SNR decreases when the column is excluded, the column should be included in the summation.

Although a single row/column optimization is illustrated in this example, the optimization may evaluate any number of rows or columns, for example 2, 3, or more rows/column may be excluded/included to evaluate if the SNR increases or decreases. Alternatively, non-array shaped regions of sub-pixels, or single pixels may be used instead. each step of the evaluation may be repeated any number of time to gain confidence in the calculation. Once the rows and columns combination that yields the maximum SNR is determined according to the local optimum, the determined sub-pixels should be summed until another change is detected.

The SNR may be determined using the average reflectivity or the average confidence level over a number of frames sampling a scene over a time duration in which the scene is similar.

This process may be repeated continually to monitor misalignments and continually optimize detection IFOV. However, since the process of optimization of the IFOV may impact the integrity of the measurements detected while the optimization is being done, the frequency of the monitoring should be considered.

Further, in some embodiments of the present disclosure, the present technique provides for periodically determining data on alignment measure based on output data received from the sensing unit, and for varying at least one of IFOV parameters, alignment of collected light reflected from said selected scene and readout of said at least one pixel of the sensing unit to improve signal to noise ratio (SNR) of said system. As indicated above, this may be performed by optimization process. In some further embodiments, the optimization process may utilize data on distribution of light impinging on the at least one pixel.

Reference is made to FIGS. 9, 10 and 11 exemplifying configurations of at least one pixel 221 and respective readout circuit 230 according to some embodiments of the present disclosure. FIGS. 9, 10 and 11 illustrate a part 221 of an optical module that includes pixel 202, interface 203, readout circuit 230 and local processor 231 and exemplify different embodiments of the present disclosure that may be implemented separately or in combination thereof.

FIG. 9 illustrates sensing module 221 including at least one pixel 202 formed of a first and a second regions 201A and 201B. Each of the first and second regions may also be formed of a plurality of sub-pixels 201(i,j) as exemplified in FIG. 9, or may be operated as a single light sensitive regions. Further in some embodiments first and second regions 201A and 201B may be formed of first and second pixels.

In this connection the LIDAR system is generally aligned to provide collected light impinging on the sensing module 221 such that the reflected light spot impinges on the at least first and second pixel regions 201A and 201B. Further, the sensing module 221 may be connected by interface 203 to readout circuit 230 to provide output data including data on light collected by each of the at least first and second pixels (or pixel regions) 201A and 201B. The readout circuit 230 and local processor 231 apply certain processing to output data collected by the sensing module and determine a relation between output signal of the first 201A and second 201B pixels (or pixel regions). The local processor 231, or processing unit 108 of the LIDAR system, utilizes the relation between light intensity impinging on the different regions of the sensing module 221, different pixels or sub-pixels 201A and 201B to determine an alignment measure of light collection. For example, if light intensity collected by first pixel region 201A is higher than light intensity collected by second pixel region 201B, the alignment measure may indicate that alignment is shifted upward, and a downward alignment shift may be needed. As indicated herein, an alignment shift may be provided by shifting IFOV of light collection by the sensing module 221, e.g., by selection of sub-pixels of the at least one pixel participating in readout of the collected light, or by shifting/aligning light collection as described herein.

FIG. 10 illustrates an additional configuration of sensing module 221 and the at least one pixel 202. In this configuration, the at least one pixel 202 includes a main pixel 201 and an arrangement of one or more additional light detectors 204(1)-204(5) located next to light sensing region of the pixel 201. The additional light detectors may be placed at any side of the main pixel 201, and may include a selected number of light detectors.

In this configuration, the LIDAR system may be configured to align light collection providing that at least a portion of illumination spot created when collected light impinges on the sensing module 221 expands beyond light sensitive region of the main pixel 201 such that some of the collected light may impinge onto one or more of the additional light detectors 204(1) to 204(5). Accordingly, readout circuit 230 receives output data from the main pixel 201 and the additional light detector 204(1) to 204(5) and provides respective output data to the local processor 231. The local processor 231 operated to determine alignment by determining intensity distribution of light portions impinging on the additional detectors 204(1) to 204(5). For example, properly aligned IFOV may be determined if for light collected of a selected relevant distance (e.g., 150 m) maximal light intensity is collected by additional detector 204(3) and certain light intensity is detected by additional detectors 204(2) and 204(4). Detection of variation of light distribution for relevant delay of collected light (relevant target distance) from expected distribution between the additional detectors may vary the alignment measure indicating a need for alignment shift to the respective direction. As indicated herein, an alignment shift may be provided by shifting IFOV of light collection by the sensing module 221, e.g., by selection of sub-pixels of the at least one pixel participating in readout of the collected light, or by shifting/aligning light collection as described herein.

FIG. 11 illustrates an additional exemplary configuration of sensing module 221 and the at least one pixel 202 thereof. In this embodiments, the at least one pixel 201 is formed of an array of sub-pixels, exemplified by 5×3 array of sub pixels 201(1,1) to 201(3,5). The readout circuit 230 is configured to collecting readout from each of the different sub-pixels 201(i,j) to enable separate processing of the individual sub-pixel readout.

To determine output data of the at least one pixel 202, the readout circuit 230 or local processor 231 may operate to determine spatial arrangement of sub-pixels providing output data indicative of light impinging thereon. The processing may utilize an initial condition that collected light reflected from an object generally generates illumination spot impinging on a local cluster of sub-pixels. This is while ambient photons may impinge of the different sub-pixels without forming a specific cluster. Accordingly, detection of a spatial cluster of sub-pixels providing output data indicative of light impinging thereon provides data on collected light. Further, to increase signal to noise ratio, and determine additional data on object parameters, the local processor 231 and/or processing unit 108 may determine data on collected light based on sub-pixels of the cluster and ignore output data of sub-pixels outside of the cluster.

This configuration enables the present technique relates to further provide sub-pixel accuracy, and improve detection of object parameters such as size, center of mass location, and/or reflectivity. Accordingly, if a target is detected by a number of one or more sub-pixels, target parameters such as reflectivity, center of mass location and target dimensions may be corrected with respect to output data collected from entire surface of the at least one pixel. For example, detection of a small target that reflects only a spatial portion of the illumination beam, may cause reflected light to impinge only on a bottom portion of the at least one pixel 202, e.g., pixels only partially covered by spot 208 in FIG. 6C. Detection of the collection light using readout from the entire pixel may indicate a larger target with low reflectivity. Identifying signal of collected light based on spatial cluster of sub-pixels providing output data indicative of light impinging thereon enables determining the boundary of the target based on the relative reflectance of each sub-pixel, making both the target position measurements and the reflectivity measurements more accurate.

In this connection, interface 203 may receive up to Nsp signals indicative of output signals from Nsp sub-pixel output and send the plurality of output signals to readout circuit 230 that in turn may provide one, some or all of the up to Nsp sub-pixel output signals to local processor 231. The local processor may determine an output signal formed of output signals of a selected number of sub-pixels. To this end, the local processor 231 may process data on spatial distribution of the sub-pixels providing non-zero output signal (indicating light impinging thereon), and determine a spatial cluster of nearby sub-pixels that provide output signal indicative of light impinging thereon. The local processor 231 may generate output data indicative of no signal, if no such cluster is identified. This is since noise if generally uniform and may result in photons impinging on the sub-pixels while not generating a spatial cluster. In case where a spatially cluster is determined, output data may be indicative of the total light collected by the cluster, generally ignoring sub-pixels that are not part of the cluster. Additionally the output data may include data on spatial arrangement of the cluster, allowing the processing unit 108 to determine additional parameters on the respective object.

Accordingly, the local processor 231 may determine which sub-pixel outputs to read. In some embodiments, the local processor 231 may convey to interface 203 which sub-pixels are to be active, and may deactivate one or more irrelevant sub-pixels.

FIG. 12 illustrates an additional exemplary configuration of a part 222 of an optical module that includes pixel 202, interface 203, readout circuit and local adder 232 and communication unit 234. The communication unit 234 is in communication with another computerized unit 240.

This configuration may operate in accordance with any one of the embodiments described above with reference to FIGS. 9 to 11, while utilizing the other computerized unit 240 over a local processor. Interface 203 may receive up to Nsp sub-pixel output signals and send them to readout circuit and local adder 232 that in turn may provide one or more sums of some or all of the up to Nsp sub-pixel output signals to the communication unit 234. The another computerized unit 240, which may generally be the at least one processor 118 or processing unit 108, may determine data on alignment measure, by determining data on location and arrangement of sub-pixels that generate output signal indicative of light impinging thereon. The another processing unit 240 may thus determine one or more IFOV parameters, alignment of light collected and/or a selection of one or more pixel output signals that are included in generating output data on light collection. For example, the another processing unit 240 may select which sub-pixel outputs to sum, and which to ignore.

FIGS. 13A and 13B schematically illustrate two exemplary operation methods according to some embodiments of the present disclosure. As shown in FIG. 13A, the method includes directing an illumination beam toward a scene 1310 and collecting reflected light from the scene by at least one pixel 1320. Following light collection, the method includes reading output data from the at least one pixel 1330. In some embodiments, the output data may be a single value data indicating of intensity of light impinging on the pixel. In some other embodiments, the output data may include two or more output data pieces indicating of light impinging on at least first and second portions of the at least one pixel. In some other embodiments, the output data may include output data from one or more additional light detectors. In some further embodiments, the output data may include a plurality of data pieces each indicative of output data of sub-pixel of the at least one pixel.

The method further includes determining an alignment measure based on the output data 1340. The alignment measure may be indicative of overlap between IFOV determined by location from which the output data is determined, and illumination spot formed by collected light impinging on the at least one pixel. In this connection the alignment measure may relate to translation variation between the IFOV and the illumination spot, size variations, or a combination thereof. Using the alignment measure, the method further includes varying one or more IFOV parameters 1350. In this connection, varying IFOV parameters may include varying alignment of light collection (or transmission toward the scene), varying location of readout area for readout from the at least one pixel, and/or varying size or shape of readout area for readout from the at least one pixel. As indicated above, adjusting readout IFOV to illumination spot of collected light may increase SNR, and may also allow determining additional data on one or more objects in the scene.

The above disclosure described several techniques for determining an alignment measure 1340. In some embodiments, alignment measure may be determined following a selected scanning period and determining one or more average parameters on collected data in the scanning period. For example, the alignment measure may be determined based on average SNR for detection of objects of selected parameters (e.g., distance between 150 m and 250 m, or between 150 m and 300 m). In some other examples described above, determining an alignment measure may be based on determining a relation between readout data collected from at least first and second (or more) pixels or pixels regions. In some additional embodiments, determining an alignment measure may be based on determining a relation between readout data collected from one or more additional light detectors. These configurations enable determining alignment measure point by point and may simplify optimization by saving scan time required for a scanning period.

FIG. 13B exemplifies an additional method according to the present disclosure. In this embodiment, the method includes directing light toward a scene 1310 and collecting reflected light by at least one pixel 1320. Here the at least one pixel is formed of an array of a plurality of sub-pixels, and configured to provide output data including data on light collected by each of the plurality of sub-pixels. Thus reading output data from the at least one pixel 1330 provides a set of data pieces (e.g., binary data pieces indicating photon impinging on sub-pixel or not). The method further includes processing the output data and determining an alignment measure 1340, including determining a spatial cluster of sub-pixels 1342 that provide output data indicative of light impinging thereon. Using data on the spatial cluster of sub-pixels, the method further includes varying IFOV parameters 1350, which in this embodiment may include selecting the sub-pixels associated with the determined spatial cluster to form the IFOV region for generating output data 1352. This configuration enables removing pixel regions that do not collect light reflected from the scene, and may further enable determining additional object parameters 1360 with improved resolution. For example, this technique enables accurate detection of object reflectivity for small objects. Further this technique enables detection of sub-pixel resolution allowing to determine object height or width with increased resolution.

FIG. 14 illustrates a LIDAR system according to further some embodiments of the present disclosure. FIG. 14 related to elements of FIG. 1 including projection unit 102, scanning unit 104, sensing unit 106 and processing unit 108 and also include an alignment unit 107, including one or more elements 117 configured for varying alignment of collected (or transmitted) light with respect to the at least one sensor 116 of the sensing unit 106. As indicated above, varying alignment of the collected light may be provided by varying orientation of the light deflector 114 or one or more optical elements used in light transmission or collection. Additionally, varying alignment of collected light may include generating shift in location of one or more pixels of the at least one sensor 116 to align IFOV for signal readout with respect to collected light.

An example of a local solution is illustrated below, and is referred to as “sense based on global optimization”.

An input to the method may be a single pixel output signal.

It is assumed that this example aims to solve optical module misalignments.

The method calculates, an average SNR for a given selection of sub-pixels as a starting point.

The average SNR may be calculated for different combinations of sub-pixels. The combinations may be obtained by removing some sub-pixels and/or adding sub-pixels. This may include looking for a combination that improves the average SNR.

When reaching a steady state, the sub-pixels that have good Rx-Tx overlap may remain, and their combination may be selected. A good Rx-Tx overlap is obtained when the receiver receives a substantial amount (for example a majority of) the energy reflected from a transmitted LIDAR spot that impinged on an object. The Rx-Tx overlap may be represent an overlap between a IFOV of a receiver and a IFOV of the transmitter.

The averaging period per combination may be long enough (E.g. few frames to minutes) to obtain a sufficient amount of information.

The method may use information over multiple frames to maximize SNR, which may mean excluding certain pixels (in certain parts of FOV, angles), or certain ranges, etc.

The method may include repeating, for each combination of multiple combinations: (i) using a readout which is the sum of all relevant sub-pixels, (ii) capture several readings (e.g. pixels, frame), and (iii) calculating SNR.

A second example may include using multiple pixel output signals concurrently—and finding best combination of relevant pixels. Decision can be made per frame.

The second example allows to perform SNR optimization, may enable to perform a correction in angular location and reflectivity estimation.

A further optimization (but with much more computational power) can be done on each point in the FOV.

For a pixel, the method we can start with the largest IFOV (a reduced IFOV from the first example be potentially used as a first step to reduce sub-pixel count and reduce complexity) and look on range detection with very high threshold (E.g. False alarm rate much higher than required but very good detection probability). Looking at that suspected detection, we can look for the best combination of sub pixels that will have the best SNR.

In the example above, an optimal combination will remove sub-pixels that do not have Rx-Tx overlap (for example the external sub-pixels of FIG. 11) and also sub-pixels that have low Tx-target overlap (A 2, A3, A4).

The method may include (i) locating the target within the pixel and therefore effectively increase system resolution. Additional attributes that can be added are Fill factor and center of mass of activated sub-pixels within Pixel (or other equivalent attribute that will address the location of object within pixel), (ii) fix reflectivity estimation based on Fill factor. For partially covered pixels, the reflectivity estimation is always bias to lower results because the reported result is effectively multiplied by the Tx to target fill factor. If the fill factor is known, the method may correct the Reflectivity estimation. In addition, the position (i.e. angles and distance) of the target may have improved resolution if the center of mass of activated sub-pixels within Pixel are used to determine the position (as opposed to the center of mass of the pixel). This may enable a resolution greater than that of each pixel, and may detect targets with sub-pixel dimensions and determine their sizes/boundaries with sub-pixel accuracy.

A sensing unit may include multiple pixels, each of the multiple pixels including multiple sub-pixels. If a sensing unit includes multiple pixels, a gradient between the signal outputs of the pixels may be used to determine if sub-pixels should be removed. For example, a 2-pixel sensing unit is considered, comprising pixel 1 and pixel 2. Pixel 1 and Pixel 2 are the same size, and have the same number of sub-pixels. If a single laser spot reflection off a uniform target (e.g. at a uniform distance with uniform reflectivity, etc.) impinges upon pixel 1 and pixel 2, each pixel may output a summed output signal. If the output signal from pixel 1 differs from the output signal of pixel 2, a gradient or ration between the signals may be calculated. If the output signal from pixel 1 is lower than the output signal from pixel 2, it may be determined that some sub-pixels from pixel 1 may be removed.

Further, if a sensing unit includes multiple, spaced apart pixels, and multiple laser spots impinge on the multiple pixels, a single global set of sub-pixels (i.e. IFOV) may be selected for each pixel, based on a maximized SNR for a subset that is the same for all pixels. This may be useful in a scenario in which the pixels have shared resources relating to signal multiplexing/muxing capabilities, e.g. the column select, row select, sub-pixel select, or sub-pixel select may be shared between all pixels. Additionally, of an IFOV (or sub-pixel) misalignment occurs due to misalignment of a common optical component, e.g. the LIDAR deflector, the correction for each pixel should be similar if the pixels are aligned with each other. In this case the determining of the selection of sub-pixels may not be according to the maximal SNR per pixel, but rather some global optimization defined (e.g. optimization of the weakest pixel signal, optimization of average SNR per-pixel with limits on non-homogeneity, etc.).

The dynamic IFOV may be controlled digitally, by controlling the of ‘active area’ of the pixel (i.e. sub-pixels selected that contribute to the output signal). The dynamic IFOV may be controlled with Optical and/or mechanical Manipulation of the projection of the sensor to the scene (e.g. moving a folding mirror, or adjusting the Tx deflector (e.g. Scanning mirror) with respect to the RX deflector (e.g. scanning mirror), if they are 2 separate scanning mirrors).

The foregoing description has been presented for purposes of illustration. It is not exhaustive and is not limited to the precise forms or embodiments disclosed. Modifications and adaptations will be apparent to those skilled in the art from consideration of the specification and practice of the disclosed embodiments. Additionally, although aspects of the disclosed embodiments are described as being stored in memory, one skilled in the art will appreciate that these aspects can also be stored on other types of computer readable media, such as secondary storage devices, for example, hard disks or CD ROM, or other forms of RAM or ROM, USB media, DVD, Blu-ray, or other optical drive media.

Computer programs based on the written description and disclosed methods are within the skill of an experienced developer. The various programs or program modules can be created using any of the techniques known to one skilled in the art or can be designed in connection with existing software. For example, program sections or program modules can be designed in or by means of .Net Framework, .Net Compact Framework (and related languages, such as Visual Basic, C, etc.), Java, C++, Objective-C, HTML, HTML/AJAX combinations, XML, or HTML with included Java applets.

Moreover, while illustrative embodiments have been described herein, the scope of any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application. The examples are to be construed as non-exclusive. Furthermore, the steps of the disclosed methods may be modified in any manner, including by reordering steps and/or inserting or deleting steps. It is intended, therefore, that the specification and examples be considered as illustrative only, with a true scope and spirit being indicated by the following claims and their full scope of equivalents.

What is claimed is:

1. A LIDAR system, comprising:
at least one light source configured for scanning a selected scene;
at least one light sensor comprising at least one pixel, said at least one pixel comprises a plurality of sub-pixels, each of said plurality of sub-pixels is configured to generate an output indicative of light collected by said respective sub-pixel; and
a processing unit configured and operable for:
receiving a plurality of outputs from said plurality of sub-pixels, each output is indicative of light received by a respective sub-pixel from said selected scene scanned by said at least one light source,
determining a subset of sub-pixels of said plurality of sub-pixels based on said outputs and one or more signal to noise ratio (SNR) criteria, and
varying a readout of said at least one pixel according to said determined subset of sub-pixels to improve signal to noise ratio (SNR) of said LIDAR system.

2-6. (canceled)

7. The LIDAR system of claim 1, wherein said processing unit determines said subset of sub-pixels by selecting an arrangement and number of sub-pixels based on said outputs and said one or more SNR criteria.

8. The LIDAR system of claim 1, wherein determining said subset of sub-pixels comprises determining an average SNR within one or more scans of said selected scene based on a relation between one or more signals associated with collected light reflected from one or more objects in the scene.

9. The LIDAR system of claim 1, wherein said at least one pixel comprises at least first and second readout regions providing readout data on light impinging on at least first and second regions of the at least one pixel, determining said subset of sub-pixels comprises determining a relation between readout data from said at least first and second readout regions.

10. The LIDAR system of claim 9, wherein said at least one pixel is configured to provide top region readout and bottom region readout indicative of light impinging on at least one of top and bottom regions or right and left regions of area of said at least one pixel.

11. The LIDAR system of claim 1, wherein said at least one light sensor comprises at least first and second pixels determining said subset of sub-pixels comprises determining a relation between readout data from at least two first and second pixels.

12. The LIDAR system of claim 1, wherein said at least one pixel comprises one or more additional light detectors located next to said plurality of sub-pixels, determining said subset of sub-pixels comprises determining intensity distribution of light impinging on said one or more additional detectors.

13. The LIDAR system of claim 7, wherein said determining of said subset of sub-pixels comprises processing a readout distribution of said subset of sub-pixels to determine signal data in accordance with a spatial cluster of said sub-pixels readout indicating data on collected light.

14. The LIDAR system of claim 13, wherein said processing unit is configured for determining a spatial cluster of sub-pixels of said subset based on said readout indicative of light reflected by at least one object and determining one or more parameters of said at least one object in accordance with an arrangement of said spatial cluster of sub-pixels.

15. The LIDAR system of claim 14, wherein said one or more parameters of said at least one object comprise object center of mass location, object dimension along at least one axis, and/or object reflectivity.

16. The LIDAR system of claim 1, wherein said processing unit is configured and operable for determining said subset of sub-pixels during typical ongoing operation.

17. A method for improving signal to noise ratio (SNR) of a LIDAR system, comprising:
receiving a plurality of outputs from a plurality of sub-pixels of at least one pixel of at least one light sensor of a LIDAR system, each output being indicative of light reflected from a selected scene scanned with light emitted by said LIDAR system and impinging on a respective one of said plurality of sub-pixels;
determining a subset of sub-pixels of said plurality of sub-pixels based on said outputs and one or more signal to noise ratio (SNR) criteria; and
varying a readout of said at least one pixel according to said determined subset of sub-pixels to improve SNR of said LIDAR system.

18-30. (canceled)

31. A computer program product comprising a computer useable medium having computer readable program code embodied therein for improving signal to noise ratio (SNR) of a LIDAR system, the computer program product comprising computer readable instructions for:
receiving a plurality of outputs from a plurality of sub-pixels of at least one pixel of at least one light sensor of a LIDAR system, each output being indicative of light reflected from a selected scene scanned by light emitted by said LIDAR system and impinging on a respective one of said plurality of sub-pixels;
determining a subset of sub-pixels from said plurality of sub-pixels based on said outputs and one or more signal to noise ratio (SNR) criteria; and
varying a readout of said at least one pixel according to said determined subset of sub-pixels to improve SNR of said LIDAR system.

32. (canceled)

33. The LIDAR system of claim 1, wherein said one or more SNR criteria are selected out of: obtaining a maximal SNR, providing a maximal SNR under a certain situation, and/or providing a maximal SNR under certain misalignments.

34. The LIDAR system of claim 1, wherein the one or more SNR criteria are associated with at least one out of: time of day, illumination conditions, a date, weather conditions, a location, and/or one or more objects that are illuminated by the LIDAR system.

35-38. (canceled)

39. The LIDAR system of claim 1, further comprising multiple aligned pixels each associated with respective light beam emitted by the at least one light source and sharing a common optical path, the at least one processor is configured to select a similar subset of sub-pixels from the plurality of sub-pixels of each of the multiple pixels.

40-41. (canceled)

42. The LIDAR system of claim 1, wherein said determining said subset comprises optimization of said subset based on evaluation of a plurality of subsets of sub-pixels with respect to said one or more SNR criteria.

43. The LIDAR system of claim 8, wherein said optimization includes evaluation of signals indicative of light reflected from at least one object in said selected scene at a specific distance from said LIDAR system.

44. The LIDAR system of claim 8, wherein said optimization includes evaluation of signals indicative of light reflected from at least one object in a specific region of said selected scene.

45. The LIDAR system of claim 1, wherein said at least one processor is configured to determine said subset of sub-pixels periodically and/or continually.

46. The LIDAR system of claim 1, wherein said at least one processor is configured to determine said subset of sub-pixels during one or more learning periods.

47. The LIDAR system of claim 46, wherein an aggregated length of the one or more learning periods is at least one of: less than one second, a duration of a single acquisition, less than a minute, and more than an hour.
